(19) United States
(12) Patent Application Publication
(10) Pub. No.: US 2026/0289086 A1
(43) Pub. Date: Sep. 24, 2026

(54) SYSTEM

(71) Applicant: SoftBank Group Corp., Tokyo (JP)

(72) Inventor: Mari ANDO, Tokyo (JP)

(73) Assignee: SoftBank Group Corp., Tokyo (JP)

(21) Appl. No.: 19/567,063

(22) Filed: Mar. 14, 2026

(30) Foreign Application Priority Data
Mar. 19, 2025 (JP) 2025-045138

(51) Int. Cl. G06F 40/166; G06F 40/205; G06F 40/253; G06F 40/268; G06F 40/284; G06F 40/295; G06F 40/30

(52) U.S. Cl. CPC G06F 40/166; G06F 40/205; G06F 40/253; G06F 40/268; G06F 40/284; G06F 40/295; G06F 40/30

(57) ABSTRACT

A system includes a processor that is configured to generate a prompt for instructing a generative AI model to generate a sentence having a specific nuance in order to convert a sentence input by a user into a sentence having the specific nuance, extract nuance patterns from past data in order to learn a plurality of nuance patterns, and incorporate a nuance pattern selected by the user into the prompt and convert the sentence input by the user by using the generative AI model based on the selected nuance pattern.

### CROSS-REFERENCE TO RELATED APPLICATION

This application is based on and claims priority under 35 USC 119 from Japanese Patent Application No. 2025-045138 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional text conversion and rewriting systems typically rely on fixed templates, rule-based transformations, or simple style selection that only adjusts limited aspects such as politeness level or length. Such systems have difficulty accurately reflecting a user's intended subtle nuance, such as “slightly angry,” “gentle but critical,” or “very polite gratitude,” in a flexible and context-appropriate manner. In addition, in many systems, nuance patterns are predetermined by designers and are not systematically learned from diverse past data, which restricts the range and richness of nuances that can be expressed. Furthermore, existing systems often lack a mechanism for analyzing the user's emotional state from the input and automatically selecting an appropriate nuance pattern, thereby requiring the user to manually trial-and-error different options. As a result, there is a need for a system that can (i) dynamically generate prompts for a generative AI model so as to instruct the model to generate sentences having a specific nuance, (ii) learn a plurality of nuance patterns from past data, and (iii) convert user-input sentences into sentences having user-selected or automatically selected nuanced expressions in a precise and efficient manner.

### SUMMARY

In order to solve the above-described problems, according to one aspect of the present invention, there is provided a system comprising a processor, wherein the processor is configured to generate a prompt for instructing a generative AI model to generate a sentence having a specific nuance, thereby enabling conversion of a sentence input by a user into a sentence having the specific nuance. The processor is further configured to extract nuance patterns from past data in order to learn a plurality of nuance patterns, so that the system can flexibly support various types of nuances beyond fixed templates. In addition, the processor is configured to incorporate a nuance pattern selected by the user into the prompt and to convert the sentence input by the user by using the generative AI model based on the selected nuance pattern. In certain embodiments, the processor is configured to analyze an emotion of the user from an input of the user by using an emotion analysis engine and to select an appropriate nuance pattern based on a result of the analysis, thereby reducing the user's burden in specifying nuances. Furthermore, the processor is configured to input the generated prompt into the generative AI model by using generative AI technology and to generate a converted sentence, thereby allowing highly expressive and context-sensitive text conversion that reflects the intended nuance.

The term “system” refers to an apparatus or a combination of hardware and software components that cooperatively execute processing, and may include one or more computers, servers, terminals, and communication interfaces.

The term “processor” refers to one or more hardware processing units, such as a central processing unit (CPU), a graphics processing unit (GPU), a digital signal processor (DSP), or any other circuitry capable of executing instructions to perform the described functions, and may also encompass a plurality of processors operating in cooperation.

The term “sentence” refers to any textual string, phrase, or sequence of words input by a user or generated by the system, regardless of grammatical completeness, punctuation, or length.

The term “nuance” refers to a style, tone, emotional coloring, politeness level, or subtle expressive characteristic of a sentence, including but not limited to being slightly angry, polite, very polite, concise, or gentle.

The term “specific nuance” refers to a particular nuance designated explicitly or implicitly, such as a user-selected nuance pattern or a nuance pattern automatically determined by the system.

The term “nuance pattern” refers to a representation of a particular nuance in a form that can be processed by the system, including rules, templates, model parameters, or statistical patterns that characterize a specific style, tone, or emotional expression.

The term “plurality of nuance patterns” refers to two or more distinct nuance patterns that differ in style, tone, emotional expression, or other expressive characteristics.

The term “prompt” refers to a text, parameter set, or structured input generated by the processor and provided to a generative AI model to instruct the generative AI model to produce an output sentence having a desired nuance or content.

The term “generate a prompt” refers to the act of the processor constructing or forming a prompt, including assembling text fragments, inserting control tokens, embedding nuance pattern information, or otherwise preparing data to be input to a generative AI model.

The term “generative AI model” refers to a machine learning model, such as a neural network-based language model, configured to generate text in response to an input prompt, and may include large language models, transformer-based models, or other generative architectures.

The term “past data” refers to previously collected or stored data, including user inputs, historical sentences, training corpora, annotated examples, or logs, from which nuance patterns can be extracted or learned.

The term “extract nuance patterns” refers to the processing in which the processor analyzes past data to identify, derive, or learn characteristic styles, tones, or emotional features, and to store them as nuance patterns usable for subsequent text conversion.

The term “learn a plurality of nuance patterns” refers to the process in which the processor uses past data, with or without machine learning algorithms, to establish, refine, or update multiple nuance patterns that can be applied to convert sentences.

The term “user” refers to a human operator who inputs text, selects nuances, or otherwise interacts with the system through a terminal or other interface.

The term “convert a sentence” refers to transforming an input sentence into another sentence by modifying its expression, tone, or structure while generally preserving its core meaning, according to a selected or determined nuance pattern.

The term “incorporate a nuance pattern into the prompt” refers to embedding, encoding, or otherwise representing information about a selected nuance pattern within the prompt so that the generative AI model is guided to generate an output sentence reflecting that nuance pattern.

The term “emotion analysis engine” refers to a software module, hardware module, or combination thereof configured to analyze user input text or other signals to estimate an emotional state, such as anger, joy, sadness, or neutrality.

The term “analyze an emotion” refers to determining, estimating, or classifying an emotional characteristic from user input by using the emotion analysis engine, including assigning one or more emotion labels or scores.

The term “appropriate nuance pattern” refers to a nuance pattern selected by the processor as suitable for a given context, user input, or detected emotion, in order to generate a sentence that reflects a desired or contextually fitting nuance.

The term “generative AI technology” refers to techniques, algorithms, and software frameworks used to operate and control generative AI models, including model inference, prompt handling, decoding strategies, and related processing.

The term “converted sentence” refers to a sentence generated by the generative AI model in response to a prompt prepared by the processor, the sentence reflecting a specific nuance as defined by a selected or determined nuance pattern.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

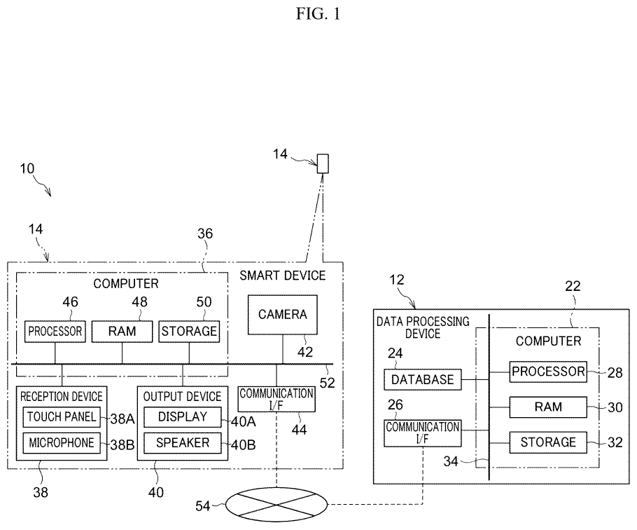

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

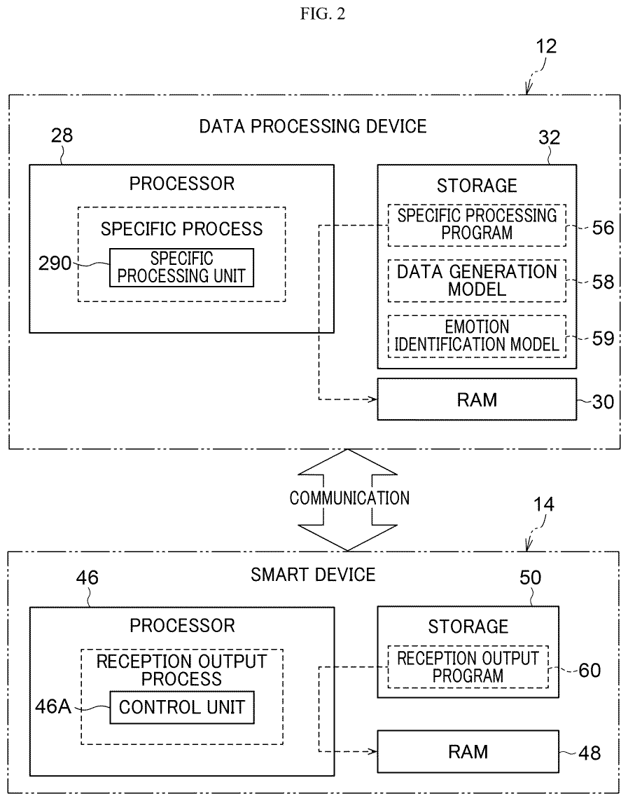

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional text conversion systems that rely on natural language processing often treat style or nuance as a fixed, rule-based post-processing step applied after basic text generation. Such systems typically use static templates or manually crafted rules to modify user input, and therefore cannot accurately capture subtle user-intended nuances such as “slightly angry” or “politely critical.” As a result, the generated text often fails to reflect the user's desired meaning while preserving the semantic content of the original input.

Furthermore, existing systems generally do not maintain a structured, learnable representation of multiple nuance patterns based on real user interactions. They either predefine a small set of coarse-grained styles, or they require manual tuning by developers. This limits the system's ability to evolve and to adapt nuance patterns over time. From the perspective of computer technology, such architectures underutilize available computation and storage resources, resulting in inefficient use of machine learning capabilities and reduced accuracy in style-controlled generation.

In addition, many systems simply pass user text to a generative AI model without constructing a context-aware prompt sentence that explicitly encodes both the input content and the desired nuance. Without a well-structured prompt sentence, the generative AI model must infer the intended nuance implicitly, which leads to inconsistent outputs, unnecessary token consumption, and degraded performance of the underlying inference pipeline. This increases computational load on the generative AI infrastructure and reduces throughput and latency characteristics of the system.

Moreover, conventional systems typically do not integrate emotion analysis engines into the prompt construction path. They do not automatically infer sentiment or emotional tone from user input and thus cannot automatically select an appropriate nuance pattern to guide the generative AI model. This omission forces the user to manually specify all stylistic parameters, increasing user burden and causing inefficiencies in human-computer interaction. From a system-level standpoint, the computing resources for emotion analysis and nuance pattern selection are not orchestrated as part of a unified processing pipeline.

Additionally, conventional architectures rarely perform systematic post-processing of the generative AI output, such as character string normalization and removal of unnecessary fragments (for example, echoed prompts or meta-instructions). Without such post-processing, the system may deliver noisy, inconsistent, or malformed output to the terminal, which degrades the usability of the overall system and requires additional manual correction by the user. This negatively affects the reliability and predictability of the text generation subsystem and increases the effective processing cost per successful interaction.

Accordingly, there is a need for a computer-implemented system that (i) receives user input and selected meaning information from a terminal, (ii) constructs a structured prompt sentence embedding both content and nuanced meaning, (iii) uses a generative AI model to perform controlled natural language processing based on that prompt, (iv) learns and updates multiple meaning patterns from accumulated past data, (v) integrates emotion analysis to automatically select appropriate meaning patterns, and (vi) performs normalization and cleanup of generated text before returning it to the terminal. Such a system would improve the functioning of the computer itself by optimizing data flows, model invocation, and post-processing, and by increasing the accuracy and consistency of nuance-controlled text generation.

The specific processing by the specific processing unit 290 of the data processing device 12 in Example 1 is realized by the following means.

The present invention provides a server comprising a processor configured to receive, via a communication path, information input by a user through a terminal and information indicating a meaning selected by the user, to construct a prompt sentence for input to a generative AI model by inserting the received user input information and the information indicating the selected meaning into a predetermined template, to transmit the constructed prompt sentence to the generative AI model and cause the generative AI model to execute natural language processing including tokenization and neural-network-based matrix operations so as to generate converted information that preserves a semantic content of the user input information while reflecting the selected meaning, to acquire the converted information from the generative AI model, to format the acquired converted information into output data in a displayable form and transmit the output data to the terminal, to store a plurality of past user input information items and corresponding meaning-indicating information items and to perform machine learning processing on the stored information so as to extract and update a plurality of meaning patterns, and to provide meaning pattern information corresponding to at least part of the extracted and updated plurality of meaning patterns to the terminal as selectable options, and further configured to optionally perform emotion estimation processing on the information input by the user using an emotion analysis engine, automatically select, based on a result of the emotion estimation processing, a meaning pattern to be incorporated into the prompt sentence from among the plurality of meaning patterns, and, after receiving the converted information from the generative AI model, perform character string normalization processing and removal processing of unnecessary portions on the converted information before outputting the converted information to the terminal. This enables improvement of computer functionality by systematically controlling the generation behavior of the generative AI model through structured prompt sentences, by adaptively learning and managing multiple meaning patterns from accumulated interaction data, by automatically selecting meaning patterns based on emotion analysis, and by delivering normalized, cleaned converted text to the terminal, thereby enhancing the accuracy, consistency, and computational efficiency of nuance-controlled text conversion.

The term “processor” refers to a hardware or virtual computation unit, including a central processing unit, a graphics processing unit, a digital signal processor, or a combination thereof, that executes machine-readable instructions to perform the functions described herein.

The term “terminal” refers to an electronic device operated by a user, such as a computing device, a communication device, or a display device, that transmits information to and receives information from a server via a communication path.

The term “communication path” refers to a logical or physical communication channel, including a wired network, a wireless network, or a combination thereof, that enables data transmission between the server and the terminal or between the server and an external service.

The term “user input information” refers to information, such as text data or other symbolic data, that is provided by the user to the system via the terminal for processing or conversion.

The term “information indicating a meaning” refers to data representing a desired nuance, style, tone, or semantic attribute specified or inferred for the user input information, including identifiers, labels, or descriptive text.

The term “meaning pattern” refers to a structured representation of a nuance, style, tone, or semantic variation that can be applied to user input information to guide generation of converted information by a generative AI model.

The term “prompt sentence” refers to a natural-language or structured text sequence constructed by the processor, including the user input information and the information indicating a meaning, that is provided as input to a generative AI model to influence its output.

The term “generative AI model” refers to a machine learning model, such as a neural network-based language model, configured to generate text or other data based on an input sequence including a prompt sentence.

The term “natural language processing” refers to processing performed by a machine learning algorithm or rule-based system to analyze, interpret, or generate human language, including operations such as tokenization, embedding computation, neural network inference, and decoding.

The term “tokenization” refers to a process of converting a text sequence into a sequence of discrete units, such as characters, subword units, or words, which are suitable for processing by the generative AI model.

The term “matrix operations” refers to arithmetic operations, such as matrix multiplication, addition, and transformation, executed within a neural network to compute intermediate and output representations from input data.

The term “converted information” refers to information generated by the generative AI model based on the prompt sentence, which preserves a semantic content of the user input information while reflecting a selected meaning or meaning pattern.

The term “output data in a displayable form” refers to data formatted so that it can be visually presented on the terminal, such as a text string or a structured response, suitable for rendering by a user interface.

The term “machine learning processing” refers to computational procedures that automatically derive patterns, parameters, or models from stored data, including training, updating, or fine-tuning algorithms to extract and update meaning patterns.

The term “meaning pattern information” refers to data representing one or more meaning patterns, including identifiers, descriptions, or metadata, that can be transmitted to the terminal and presented as selectable options to the user.

The term “emotion analysis engine” refers to a software or hardware component configured to estimate emotional attributes, such as sentiment polarity or intensity, from user input information by using statistical, rule-based, or machine learning techniques.

The term “emotion estimation processing” refers to operations performed by the emotion analysis engine to analyze user input information and to output emotion-related characteristics, such as emotion category or strength.

The term “character string normalization processing” refers to processing that converts text into a standardized representation, including operations such as unifying character forms, adjusting whitespace, or harmonizing punctuation.

The term “removal processing of unnecessary portions” refers to processing that eliminates extraneous elements from generated text, such as echoed prompts, meta-instructions, superfluous symbols, or other content not intended for presentation to the user.

In one embodiment, a server executes a text conversion program that implements the claimed system. The server includes at least one processor, a main storage device, a non-transitory storage device, and a network interface. The server runs an operating system such as a general-purpose server operating system, and application software including a web application framework, an application program implementing prompt construction and result post-processing, a machine learning framework, and a generative AI model. The server is communicatively coupled to at least one terminal via a wired or wireless communication network. The terminal includes a processor, a display, an input interface, a memory, and a communication module, and executes either a web browser or a native application that provides a graphical user interface for user interaction.

The server stores, in the non-transitory storage device, executable instructions implementing modules such as a communication module, a prompt construction module, a generative AI interface module, a meaning-pattern learning module, an emotion analysis module, and a result post-processing module. The server loads these modules into the main storage device and causes the processor to execute the modules. The terminal stores, in a storage device, instructions implementing a user interface module, an input acquisition module, and a response rendering module. The terminal loads these instructions into its memory and causes its processor to execute the instructions.

The server uses a machine learning framework, such as a general neural-network framework, to host a generative AI model that operates as a sequence-to-sequence language model. In one embodiment, the generative AI model is implemented as a transformer-based neural network including an embedding layer, a plurality of self-attention layers, feed-forward layers, layer normalization components, and an output projection layer. The server configures the generative AI model with parameters including a vocabulary size, an embedding dimension, a number of attention heads, a number of transformer blocks, and a maximum sequence length. The server initializes the model with pre-trained weights stored in the storage device and may further fine-tune the model using domain-specific data stored in a training dataset.

The server uses the generative AI model to generate converted information from a prompt sentence. The server performs tokenization of the prompt sentence using a tokenizer that maps character strings into integer token identifiers based on a vocabulary. The server inputs the token identifiers into the embedding layer, which converts each token identifier into a continuous vector representation. The server then applies a series of transformer blocks, each performing matrix multiplications, attention weight computations, non-linear activation functions, and residual connections, to compute contextualized representations of each token.

The server finally applies an output projection layer and a softmax function to compute probability distributions over the vocabulary for each time step, and decodes the most probable sequence of tokens as the converted information.

The server trains or adapts the generative AI model using historical interaction data stored in the storage device. The server uses an objective function such as cross-entropy loss between the predicted token distribution and target token sequences. The server updates the model parameters using an optimization algorithm such as stochastic gradient descent or a variant thereof. The server optionally applies data augmentation techniques, such as paraphrasing or synonym replacement of training sentences, to improve robustness. The server may also apply regularization techniques, such as dropout within the transformer blocks, to prevent overfitting and to stabilize training.

The server manages meaning patterns as structured data objects stored in a database. Each meaning pattern includes at least a pattern identifier, a textual description (for example, “slightly angry,” “polite,” or “formal”), one or more example sentences illustrating the pattern, and statistical attributes derived from past usage, such as frequency of selection or average emotion scores. The server updates these meaning patterns based on actual user interactions, thereby learning new patterns and refining existing patterns over time. The server uses a clustering algorithm, such as k-means or hierarchical clustering applied to embedding vectors of generated texts, to group similar styles and derive new meaning patterns. The server thereby improves the internal representation and management of nuance, which leads to more accurate and consistent text generation.

The terminal presents to the user a list of meaning patterns as selectable options on the display. The terminal uses a user interface framework to render selection components, such as drop-down menus, radio buttons, or toggle buttons. The user selects a desired meaning pattern by operating a pointing device or a touch panel. The terminal records the selected meaning pattern as a data value, such as a pattern identifier or a description string. The terminal may also allow the user to input free-form text describing a desired nuance, which the server can map to an existing, nearest, or newly created meaning pattern by computing similarity between embedding vectors.

The terminal further displays a text input area, such as a text field, where the user inputs original text to be converted. The user types or pastes the text into the text field. The terminal acquires the text using an input acquisition module and combines it with the selected meaning pattern into a transmission object. The terminal transmits the transmission object to the server via a network protocol, such as HTTP over TLS, and includes metadata such as a session identifier or a user identifier when appropriate.

The server receives the user input information and the information indicating the selected meaning pattern via the communication path. The server parses the received data using the communication module, checks consistency and validity of the fields, and stores the information in a request buffer in memory. The server then invokes the prompt construction module. The server loads a predetermined prompt template from a configuration storage. The prompt template may include placeholders for the original text and for the meaning description.

The server constructs a prompt sentence by inserting the original text and the meaning description into the template. For example, the server may construct a prompt sentence in Japanese in the following form:
Input text: “Your behavior is unacceptable.”
Nuance: “Slightly angry”
Please generate an output sentence.

The server may alternatively construct a prompt sentence in English or another language. For example:
Input sentence: “I cannot forgive your behavior.”
Nuance: “slightly angry”
Please generate an output sentence that preserves the meaning of the input sentence and reflects the given nuance.

The server may also use a more detailed prompt sentence specifying constraints on politeness level, length, or vocabulary. For example:
You are a text style converter.
Original text: “Your behavior is unacceptable.”
Desired nuance: “Slightly angry”
Please output a Japanese sentence that keeps the same meaning but sounds slightly angry without being extremely aggressive.

The server performs string concatenation and formatting operations to generate these prompt sentences, and normalizes the character encoding and line break format. The server stores the constructed prompt sentence in a prompt buffer and passes it to the generative AI interface module.

The server uses the generative AI interface module to input the prompt sentence into the generative AI model. The server performs tokenization, batch formation, and, if necessary, padding or truncation to adapt the prompt to the model's maximum sequence length. The server configures decoding parameters, such as temperature, top-k sampling, top-p sampling, maximum output length, and stop tokens, to control stochasticity and length of the generated text. The server then executes the forward-inference computation of the generative AI model on the hardware, such as a central processing unit or graphics processing unit. The server records the computational time and resource usage for optimization and monitoring.

The server receives the raw generated token sequence from the generative AI model and decodes the token identifiers back to a character string. The server applies character string normalization, such as unifying full-width and half-width characters in certain languages, normalizing case, and adjusting whitespace and punctuation to conform to display rules. The server further performs removal processing of unnecessary portions, such as removing repeated prompt text that might have been echoed by the model, stripping meta-instructions that the model inserted (for example, “Here is the output sentence:”), and cutting off text following undesired delimiters. The server thereby obtains clean, user-ready converted information.

The server uses an emotion analysis module to perform emotion estimation processing on the user input information. The server may implement the emotion analysis module as a separate neural network model, such as a classifier that maps tokenized text to emotion categories or continuous sentiment scores. The server tokenizes the original text, embeds the tokens, and forwards them through several neural network layers, such as convolutional layers, recurrent layers, or transformer layers, and applies a softmax or regression layer to output emotion probabilities or scores. The server selects the most probable emotion or computes an intensity measure. Based on the emotion analysis result, the server selects or adjusts a meaning pattern automatically by matching the emotion profile with the stored meaning patterns. The server may modify weight parameters in a rule for mapping emotions to meaning patterns, thereby improving automatic selection over time. The server can thus construct a prompt sentence that incorporates a meaning pattern aligned with the user's apparent emotion, even if the user did not explicitly specify the nuance.

The server stores historical interaction data, including user input texts, selected meaning patterns, emotion estimation results, and outputs of the generative AI model, in a database. The server periodically executes the meaning-pattern learning module to analyze this stored data. The server computes sentence embeddings for user inputs and generated outputs using a separate embedding model or the internal states of the generative AI model. The server then applies clustering or dimensionality reduction algorithms to group similar styles or nuances and to detect underrepresented or new clusters. The server updates the meaning pattern records with new cluster centroids, label suggestions, or example sentences. The server may also adjust the mapping between emotion analysis results and meaning patterns based on statistics observed in real interactions. This data-driven adaptation differentiates the system from simple rule-based automation and leads to improved precision and stability of nuance control.

The server formats the final converted information and associated metadata, such as the applied meaning pattern identifier and confidence scores, into a response structure. The server converts this structure into a response message and transmits it to the terminal via the communication path. The terminal receives the response, parses it, and renders the converted information in a display area on the user interface. The terminal may display, for example, the original text and the converted text side by side, along with an indication of the applied nuance, to allow the user to verify the result. The user can then decide whether to accept the converted text, to select a different meaning pattern, or to modify the original text and request a new conversion.

The server, by using the structured prompt sentence, reduces ambiguity for the generative AI model and constrains the generation behavior to a more specific region of the model's parameter space. This targeted conditioning reduces the number of tokens needed to obtain a satisfactory output and decreases the variance of the generated responses. As a result, the server reduces inference time and communication load between the server and any external model host. The server's learning and management of meaning patterns enable reuse of optimized prompt constructions, further improving processing speed and consistency. The integration of emotion analysis allows the server to automatically select appropriate meaning patterns, which reduces unnecessary back-and-forth interactions and lowers overall computational overhead while improving accuracy of nuance reflection.

The server improves computer technology by optimizing the internal data flow and by coordinating specialized modules (prompt construction, emotion analysis, meaning-pattern learning, and post-processing) with the generative AI model. The server does not merely automate a human editing process; instead, the server reorganizes the inference pipeline to exploit the generative AI model's architecture in a non-conventional way, using structured prompts and learned meaning patterns to achieve higher precision and lower resource consumption. The combination of stored meaning patterns, continuous model adaptation, and strict post-processing rules ensures that the computing system produces stable, high-quality outputs that would be difficult to achieve manually or with generic, unstructured prompts.

The server may be implemented in different deployment configurations. In one variant, the server hosts the generative AI model locally on a high-performance computing unit, such as a server with multiple graphics processing units, for low-latency processing. In another variant, the server acts as a gateway to an external generative AI service, using the same prompt construction and post-processing techniques while delegating the core neural inference to an external resource. In yet another variant, the terminal itself may host a lightweight generative AI model for offline operation, while the server primarily manages meaning-pattern learning and distribution. In all of these embodiments, the described architecture of constructing prompt sentences, managing meaning patterns, integrating emotion analysis, and performing output normalization remains applicable and provides the same technical advantages.

The terminal may also provide additional controls that allow the user to adjust generation parameters, such as degree of creativity or strictness of adherence to the original text. The terminal transmits these parameter values to the server, and the server integrates them into the decoding configuration for the generative AI model. By adjusting parameters such as temperature or maximum token count, the server can trade off between diversity and determinism in the generated text. This parameter control contributes to efficient computation by allowing the system to reduce unnecessary exploratory output when a highly constrained, deterministic rewriting is sufficient.

Thus, by structuring the internal data representations, by defining explicit modules and algorithms for constructing prompt sentences and learning meaning patterns, and by tightly integrating emotion analysis and post-processing, the server realizes a technical improvement in how text is generated, managed, and delivered in a computer system. The system achieves faster processing times, higher accuracy in nuance reproduction, reduced error rates from malformed outputs, and more efficient use of computational and communication resources than conventional, less structured approaches.

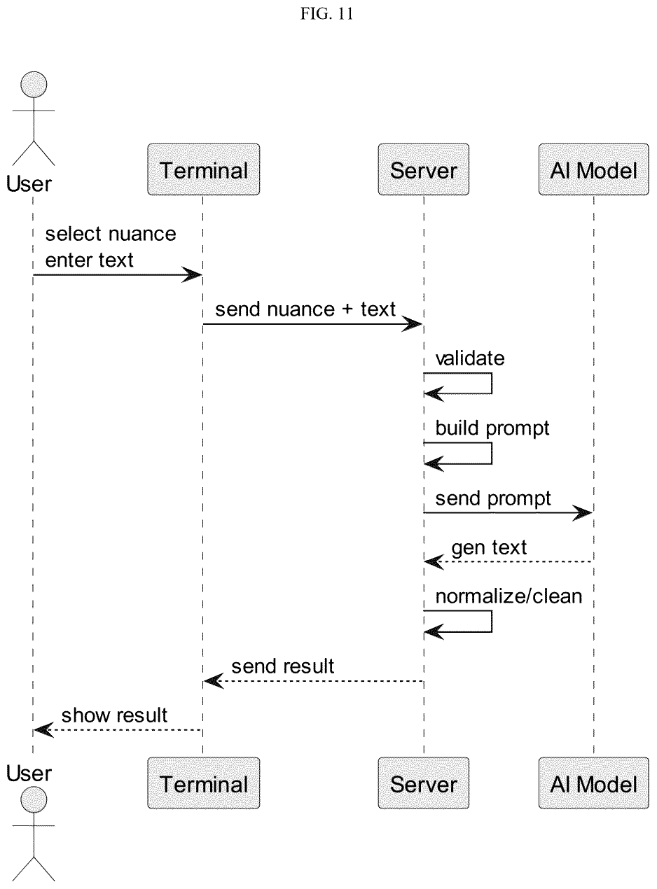

The following describes the processing flow using FIG. 11.

### Step 1:

The terminal displays a user interface that shows a list of selectable meaning patterns and a text input area.

The user selects one meaning pattern (for example, “slightly angry”) using a touch operation or a pointing device and inputs original text (for example, “I cannot forgive your behavior”) into the text input area.

The terminal acquires, as input, the selected meaning pattern and the original text from internal UI components.

The terminal constructs, as output, a structured data object including at least a meaning pattern identifier or description and the original text, by storing these values in predefined fields of an in-memory data structure.

### Step 2:

The terminal transmits the structured data object to the server via a network connection.

The terminal uses a communication module to serialize the data object into a message format and sends it using a network protocol.

The server receives, as input, the serialized message containing the meaning pattern data and the original text through its network interface.

The server parses, as output, the message into an internal request object by decoding the message format and mapping each field into corresponding variables in memory.

### Step 3:

The server validates the received data.

The server uses the internal request object as input, checks whether the original text is non-empty and whether the meaning pattern identifier is included in a stored list of valid patterns.

The server outputs either a validation success result or an error result by evaluating conditional branches based on the content of the internal request object.

If an error is detected, the server generates an error response object and transmits it back to the terminal; otherwise, the server passes the validated request object to a prompt construction module.

### Step 4:

The server constructs a prompt sentence for a generative AI model.

The server takes, as input, the validated original text and the meaning pattern description from the request object.

The server loads a predefined prompt template from configuration storage and inserts the original text and the meaning pattern description into placeholder positions using string concatenation and formatting operations.

The server outputs a complete prompt sentence, such as:
Input text: “I cannot forgive your behavior.”
Nuance: “slightly angry”
Please generate an output sentence.
or:
Input sentence: “I cannot forgive your behavior.”
Nuance: “slightly angry”

Please generate an output sentence that preserves the meaning of the input sentence and reflects the given nuance.

### Step 5:

The server performs tokenization and prepares model input.

The server receives, as input, the constructed prompt sentence.

The server applies a tokenizer to the prompt sentence, converting each character sequence into an integer token identifier based on a vocabulary table stored in memory.

The server pads or truncates the resulting token sequence to satisfy a maximum sequence length constraint of the generative AI model and outputs a model-ready input tensor that encodes the token sequence as numerical data.

### Step 6:

The server executes inference of the generative AI model.

The server inputs the prepared tensor into the generative AI model, which is a transformer-based neural network stored and executed on the server.

The server performs matrix operations, including multiplication of the token embeddings with weight matrices in self-attention and feed-forward layers, and applies activation functions and softmax operations to compute probability distributions over the vocabulary for each decoding step.

The server outputs a sequence of predicted token identifiers representing converted information that preserves the semantic content of the original text while reflecting the selected meaning pattern.

### Step 7:

The server decodes the generated token sequence into text.

The server receives, as input, the predicted token identifier sequence from the generative AI model.

The server applies a reverse mapping from token identifiers to character strings using the vocabulary table, concatenates the character strings, and reconstructs a natural-language sentence.

The server outputs a raw generated sentence, which may include additional whitespace, echoed prompt content, or meta-phrases.

### Step 8:

The server performs character string normalization and removal of unnecessary portions.

The server uses the raw generated sentence as input and applies normalization operations, such as unifying character forms, adjusting whitespace, and harmonizing punctuation according to language-specific rules.

The server then scans the normalized sentence for unnecessary portions, such as repeated segments of the prompt sentence or explanatory phrases introduced by the model, and removes them using substring detection and pattern matching.

The server outputs a cleaned converted sentence that is ready for display on the terminal.

### Step 9:

The server optionally applies emotion analysis to refine or log meaning patterns.

The server uses the original text and, optionally, the generated converted sentence as input to an emotion analysis engine.

The server tokenizes this text again, feeds the tokens into an emotion classification model, computes emotion scores or probabilities, and associates these scores with the current meaning pattern in a meaning-pattern database.

The server outputs updated meaning pattern statistics or mapping data, which the server stores for future learning and optimization of pattern selection.

### Step 10:

The server constructs a response for the terminal.

The server receives, as input, the cleaned converted sentence and any associated metadata, such as the applied meaning pattern and confidence scores.

The server places these values into a response object by assigning them to predefined fields and serializes the response object into a transmission format.

The server outputs a serialized response message and transmits the message to the terminal via the communication module.

### Step 11:

The terminal receives and renders the converted sentence.

The terminal uses the serialized response message as input and parses the message into a response object containing the converted sentence and related metadata.

The terminal updates the user interface by assigning the converted sentence to a text display area and optionally showing the applied meaning pattern and other indicators.

The terminal outputs a visual representation of the converted sentence on the display, enabling the user to inspect the result and decide whether to accept it or perform another conversion.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer systems that support creation of advertising messages typically rely on fixed rule sets, static templates, or manual editing by human creators. Such systems merely provide simple text suggestions or keyword substitution functions and do not dynamically adapt sentence generation to nuanced emotional requirements, such as conveying excitement, luxury, or reassurance, in a fine-grained and context-aware manner. As a result, the burden on a user remains high, because the user must repeatedly trial-and-error edit generated text in order to match a desired nuance.

Furthermore, in many existing systems that utilize a generative AI model, the interaction with the model is implemented in an ad-hoc fashion: a prompt sentence is manually written or is hard-coded, and the system does not systematically manage or update nuance patterns or style constraints based on accumulated input and output data. This leads to inefficiencies in the use of computing resources, because the generative AI model is repeatedly invoked with sub-optimal prompt sentences that do not fully leverage the model's capabilities. In addition, such systems do not provide a structured mechanism to learn from past data how different nuances should be expressed, and therefore cannot improve generation quality over time in a computer-implemented, data-driven manner.

Moreover, existing systems generally treat the generative AI model as a black box for one-shot conversion and do not incorporate a processor-implemented pipeline that performs: (i) standardized reception of user input and nuance information from a terminal, (ii) retrieval and adaptation of nuance patterns and associated style constraint information from storage, (iii) programmatic construction of prompt sentence data that encodes both semantic intent and stylistic requirements, and (iv) logging, analysis, and updating of these patterns based on observed results. This absence of a structured pipeline prevents the system from optimizing prompt design and from reducing unnecessary model calls or revisions, thereby limiting scalability and responsiveness.

Accordingly, there is a need for an improved computer-implemented system and server-side processing architecture that: (1) programmatically generates prompt sentence data incorporating nuance patterns and style constraints; (2) interacts with a generative AI model in a standardized, reusable format; and (3) learns from accumulated log data to update nuance patterns and style constraint information. Such a system should reduce the computational and cognitive load associated with repeated manual adjustments, increase the consistency and controllability of generated text, and improve overall system performance in terms of quality, efficiency, and adaptability of advertising message generation.

The specific processing by the specific processing unit 290 of the data processing device 12 in Application Example 1 is realized by the following means.

The present invention provides a server comprising a processor configured to receive sentence data and nuance information input by a user via an information processing terminal, obtain, from a storage unit, a nuance pattern corresponding to the nuance information, generate prompt sentence data including the sentence data and the nuance pattern, transmit the prompt sentence data to an external generative artificial intelligence model and obtain, from the generative artificial intelligence model, converted sentence data to which a nuance is added, transmit the converted sentence data to the information processing terminal and generate output data for display of the converted sentence data to the user on the information processing terminal, extract, based on past input and output data, a plurality of nuance patterns, update the plurality of nuance patterns and generate learning data to be used for generation of the prompt sentence data, and manage the nuance patterns in association with style constraint information and incorporate the style constraint information into the prompt sentence data. This enables a computer-implemented processing pipeline in which the server systematically constructs optimized prompt sentence data, interacts with the generative AI model using the optimized prompt sentence data, and incrementally refines nuance patterns and style constraint information based on accumulated log data, thereby improving the technical performance of the system in terms of generation quality, controllability of nuanced output, and efficiency of computing resources.

The term “processor” refers to a hardware and/or software computing resource, such as a central processing unit, a graphics processing unit, or a set of executable software modules, that is configured to execute instructions and perform the operations described in the claims.

The term “information processing terminal” refers to an electronic apparatus, such as a smartphone, a tablet device, a notebook computer, or a desktop computer, that is configured to communicate with a server, receive and transmit data, and provide a user interface for input and output of information.

The term “user” refers to a human operator or an organizational entity that interacts with the information processing terminal to input sentence data and nuance information, and to receive and review converted sentence data.

The term “sentence data” refers to character string data representing at least one sentence, phrase, or text segment that is input by the user and is to be processed, converted, or transformed by the system.

The term “nuance information” refers to data indicating a desired emotional tone, style, mood, or communicative intent to be reflected in the converted sentence data, including but not limited to excitement, calmness, luxury, or reassurance.

The term “storage unit” refers to a memory resource, such as a main memory, a non-volatile memory, a magnetic storage device, or a solid-state storage device, that is configured to store data including nuance patterns, style constraint information, and log data.

The term “nuance pattern” refers to a data structure that represents a particular type of nuance, including at least a label, a description of an emotional or stylistic characteristic, and optionally associated parameters that are used to control generation or conversion of sentence data.

The term “prompt sentence data” refers to text data formatted as an instruction or request for a generative artificial intelligence model, the text data including at least sentence data, nuance patterns, and optionally style constraint information, and being used to cause the generative artificial intelligence model to generate converted sentence data.

The term “generative artificial intelligence model” refers to a machine-implemented model, such as a neural network model, that is configured to generate or transform text based on input prompt sentence data and that outputs converted sentence data reflecting the content and constraints contained in the prompt sentence data.

The term “converted sentence data” refers to text data output by the generative artificial intelligence model in response to the prompt sentence data, the text data representing a version of the sentence data to which a nuance, style, or emotional tone has been added or modified.

The term “output data” refers to data generated by the processor that includes or is derived from the converted sentence data and that is formatted for presentation on the information processing terminal, such as display data for a graphical user interface.

The term “past input and output data” refers to accumulated data records including at least previously received sentence data, associated nuance information, corresponding prompt sentence data, and converted sentence data that have been generated by the system over time.

The term “learning data” refers to data derived from analysis of past input and output data, including updated nuance patterns, statistical parameters, or configuration values, which are used to improve or adapt the generation of prompt sentence data and the control of the generative artificial intelligence model.

The term “style constraint information” refers to data defining constraints or requirements on the style of text to be generated, such as length limits, formality level, tone characteristics, punctuation usage, or other formatting or stylistic rules.

The term “log data” refers to stored records of operations performed by the system, including at least prompt sentence data, converted sentence data, timestamps, selected nuance patterns, and other related metadata used for analysis and updating of system behavior.

In one embodiment, a server cooperates with a terminal operated by a user to implement a system that generates nuanced text by controlling a generative AI model through structured prompt sentence data. The server includes at least one processor, a main memory, a non-volatile storage unit, and a network interface. The terminal includes at least one processor, a display device, an input device such as a keyboard or touch panel, and a communication interface. The server and the terminal communicate via a communication network such as the Internet using a protocol such as HTTPS.

The server uses an application framework such as a web application framework (for example, a framework implemented in a scripting language or a high-level language) to implement business logic. The server uses an external generative AI model implemented, for example, as a large-scale neural network with a transformer architecture provided via an API. The server sends prompt sentence data to the generative AI model and receives converted sentence data as a response.

The server stores, in the storage unit, a plurality of nuance patterns and associated style constraint information. Each nuance pattern is represented as a structured record including at least a label (for example, “excited,” “calm,” “luxurious,” “reassuring”), a natural-language description of the intended emotional tone, and one or more references to style constraint records. Each style constraint record contains parameters such as a character length limit, an indication of formality level, a desired punctuation pattern (for example, use or non-use of exclamation marks), and optional lexical preferences (for example, words to emphasize benefits or to convey reliability). The storage unit maintains these records in an indexed data structure, such as a relational table or a key-value mapping, enabling efficient retrieval based on nuance labels or identifiers.

The terminal presents to the user an input interface implemented, for example, as a web page rendered in a browser or as a native application. The terminal provides a text input region where the user enters original sentence data, and a selection region where the user selects nuance information. The terminal transmits the entered sentence data and selected nuance information to the server as structured data via the communication interface.

The server receives the sentence data and nuance information and retrieves, from the storage unit, a nuance pattern corresponding to the received nuance information. The server also retrieves style constraint information associated with the nuance pattern. The server constructs prompt sentence data by combining the sentence data, the nuance pattern, and the style constraint information according to a predefined template. The server uses string-processing functions to embed the original sentence as a quoted part, to insert the nuance label and description, and to append explicit style conditions.

For example, when the user inputs the sentence “This product is wonderful” and selects a nuance corresponding to the concept “excitement,” the server can generate a prompt sentence such as:
You are a Japanese advertising copywriter.
Please rewrite the following sentence into advertising copy that strongly conveys excitement and has a tone that makes the reader want to buy it immediately.
Input sentence: “This product is wonderful”
Nuance: Want to convey excitement
Condition: Use exclamation marks and add expressions that heighten the reader's emotions.
Please return only one rewritten sentence as the output.

In another example, when the user selects a nuance corresponding to the concept “luxury,” the server can generate a prompt sentence such as:
You are a copywriter for Japanese luxury brands.
Please rewrite the following sentence into advertising copy that conveys a sense of luxury and high quality.
Input sentence: “This product is wonderful”
Nuance: Want to convey a sense of luxury
Condition: Use an elegant and calm tone, and use expressions that do not make it feel cheap.
Please return only one rewritten sentence as the output.

In a further variation, the server can generate an English-language prompt controlling Japanese-language output, for example:
You are a professional Japanese advertising copywriter.
Rewrite the following Japanese sentence as an ad that strongly reflects the given nuance, while keeping the output in natural Japanese.
Original sentence: This product is wonderful.
Nuance: convey excitement and urgency to buy now.
Constraints: use exclamation marks and keep it within 30-50 Japanese characters.
Output only the rewritten Japanese sentence.

The server transmits the generated prompt sentence data to the external generative AI model. The generative AI model can be implemented as a transformer-based neural network with multiple attention layers, feed-forward layers, and embedding layers. The generative AI model internally tokenizes the prompt sentence into subword tokens, computes contextual embeddings through stacked self-attention blocks, and outputs token probability distributions step-by-step. The generative AI model uses parameters such as temperature, top-p, and maximum output length to control randomness and output length. The generative AI model is trained in advance on large-scale text corpora by minimizing a loss function such as cross-entropy between predicted tokens and ground-truth tokens, and by updating network weights using a gradient-based optimization algorithm such as stochastic gradient descent with momentum or an adaptive method.

The server receives the converted sentence data from the generative AI model, converts the token sequence into a text string, and performs post-processing. The server can remove undesired surrounding explanations, trim whitespace, and check whether the converted sentence meets basic formatting constraints. The server then generates output data, including the converted sentence data, and transmits the output data to the terminal, which displays the converted text to the user.

The server maintains log data including the original sentence data, the selected nuance information, the generated prompt sentence data, and the converted sentence data. The server uses the log data as past input and output data. The server analyzes the log data using predetermined algorithms to refine nuance patterns and style constraint information. For example, the server may compute statistical measures such as average length of generated sentences for each nuance, frequency of punctuation usage, and presence of prescribed lexical features. Based on these measures, the server can adjust style constraint parameters, such as tightening or loosening length constraints or modifying instructions about punctuation.

In one embodiment, the server uses a learning component that automatically updates nuance patterns and style constraint information without re-training the underlying generative AI model. The server can, for example, cluster converted sentence data by similarity in embedding space and associate representative phrases with nuance patterns. The server can represent each converted sentence by a vector of numerical features, such as n-gram frequencies, sentence length, character type ratios, and sentiment scores. The server uses these feature vectors to identify systematic differences among generated outputs and to refine the textual descriptions of nuance patterns so that future prompt sentences more precisely reflect desired stylistic dimensions.

In another embodiment, the server applies emotion analysis to the sentence data input by the user. The server uses an emotion analysis engine implemented as a separate neural network model (for example, a bidirectional recurrent network, a transformer encoder, or a convolutional text classifier) that is trained to output emotion categories or scores such as joy, anger, fear, surprise, or trust. The emotion analysis engine takes as input tokenized sentence data and outputs an emotion distribution vector. The server maps this vector to one or more nuance patterns using a rule-based mapping or a learned mapping, thereby automatically selecting nuance patterns based on detected emotion. The server incorporates the automatically selected nuance patterns into the prompt sentence data, thereby adapting the generative AI model's behavior to latent emotional content of the input text.

The server improves computer technology in several ways. First, the server off-loads part of the control logic for the generative AI model from manual prompt design to a structured, data-driven prompt generation process. The server manages nuance patterns and style constraints as explicit data structures and dynamically composes prompt sentence data based on these structures. This reduces repeated trial-and-error user interactions and reduces the number of excessive calls to the generative AI model, thereby reducing network traffic and latency.

Second, the server uses the accumulated log data as feedback to optimize the internal configuration for prompt generation. By analyzing patterns in the input and output pairs, the server adjusts nuance patterns and style constraints, which leads to more accurate and stable output from the generative AI model. As a result, the server reduces variance in model behavior, avoiding overlong or off-topic outputs, which improves overall computational efficiency because fewer corrective re-requests are necessary. The causal relationship here is that better-structured prompt sentence data, derived from empirically optimized nuance patterns and style constraints, results in more consistent output distributions from the generative AI model, thus reducing computational waste.

Third, the server can implement caching strategies based on normalized representations of input sentence data and nuance patterns. When the server detects that a new input matches or is similar to a previously processed combination (for example, by computing a similarity score between embeddings of input sentences and stored embeddings), the server can reuse stored converted sentence data, thereby avoiding unnecessary calls to the generative AI model. This caching mechanism further reduces network load and compute time, and contributes to technical improvements in throughput and responsiveness.

Fourth, the server enforces non-conventional processing steps that differ from simple human editing. The server does not merely replicate human drafting behavior; instead, the server uses algorithmic rules for mapping nuance patterns and style constraints onto prompt sentence structures, such as canonical ordering of instructions, explicit delineation of input and output roles, and inclusion of constraint keywords. These algorithmic rules are designed to align with the internal operation of transformer-based generative models, which are sensitive to context order and explicit constraints. The server's control of prompt sentence formatting therefore directly influences the sequence of attention weights and token probabilities inside the generative AI model, resulting in improved generation accuracy and reduced ambiguity.

In alternative embodiments, the server can interact with different types of generative AI models, such as encoder-decoder models, sequence-to-sequence models with attention, or fine-tuned language models specialized for advertising domains. The server can store separate nuance pattern sets for different domains (for example, technology products, cosmetics, financial services) and can select a domain-specific nuance pattern set based on metadata associated with the user or the product. The server can also adjust style constraint information to match platform requirements, such as character limits for messaging services or display constraints for small screens.

In another embodiment, the terminal can be a specialized device embedded in a kiosk or a digital signage controller. In this case, the terminal uses the converted sentence data to dynamically update content for physical displays, such as electronic posters or in-store screens. The server thereby indirectly controls display devices in the physical world through the conversion of sentence data, demonstrating a technical application beyond pure business logic. By optimizing the prompt generation and conversion pipeline, the server ensures that updated content is generated and transmitted within tight time constraints, improving real-time responsiveness of the signage system.

In yet another embodiment, the server can be configured to integrate with a distributed computing infrastructure. The server can schedule calls to the generative AI model based on system load, splitting traffic among multiple model endpoints or instances. The optimization of prompt sentence data, achieved through the nuance pattern and style constraint management described above, contributes to more predictable request sizes and response lengths, which helps the server maintain stable resource allocation, reduce queue times, and enhance overall quality of service.

Through these embodiments, the server, the terminal, and the user cooperate in a technical system where the server implements structured data processing and learning-based configuration updates to control the behavior of an external generative AI model via prompt sentence data. The system does not merely automate human writing but improves computer technology by introducing new internal data structures, non-conventional processing steps, and feedback-driven optimization mechanisms that enhance processing speed, accuracy, resource efficiency, and management of complex text generation tasks.

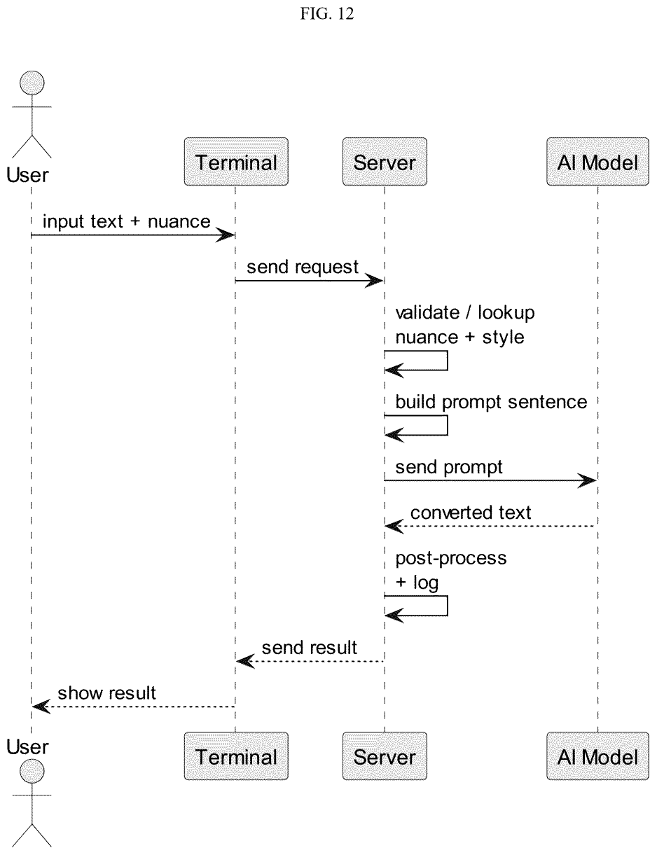

The following describes the processing flow using FIG. 12.

### Step 1:

User operates the terminal to launch an application and access a text input interface.

User inputs original sentence data into a text field (input: raw text string) and selects nuance information from a list (input: nuance label such as “excited” or “luxurious”).

Terminal receives these inputs via an input device (for example, keyboard or touch panel) and performs basic validation, such as checking that the text string is not empty and that a nuance label is selected.

Terminal then structures the validated inputs into an internal data object (output: structured input data including sentence data and nuance information).

### Step 2:

Terminal transmits the structured input data to the server via a communication interface using a network protocol (for example, HTTPS).

Input to this step is the internal data object containing the original sentence data and nuance information.

Terminal converts this object into a serialized format (for example, JSON) and adds communication metadata such as headers and endpoint information.

Output of this step is a network request containing the serialized input data that is sent to the server.

### Step 3:

Server receives the network request via a network interface and passes the request to an application layer.

Input to this step is the serialized data received from the terminal.

Server deserializes the data (for example, parses JSON) into an internal representation and extracts fields such as the original sentence, the selected nuance label, and optional language metadata.

Server performs validation and normalization, such as trimming whitespace, limiting the maximum length of the sentence, and verifying that the nuance label is supported.

Output of this step is a validated and normalized input object ready for further processing.

### Step 4:

Server accesses a storage unit to retrieve a nuance pattern corresponding to the selected nuance label.

Input to this step is the normalized input object including the nuance label.

Server executes a database query or key-value lookup to obtain a nuance pattern record (for example, label, description, and associated identifiers) and associated style constraint records (for example, length constraints, formality level, punctuation rules).

Server then combines the retrieved records into an internal structure representing the selected nuance and its style constraints.

Output of this step is a combined nuance configuration object containing nuance pattern information and style constraint information.

### Step 5:

Server generates prompt sentence data by combining the original sentence data with the nuance configuration object according to a predefined template.

Input to this step is the normalized input object (including sentence data) and the combined nuance configuration object.

Server performs string concatenation and formatting operations to embed the original sentence as an input example, insert the nuance description, and explicitly state style constraints.

Server may include system-level instructions such as a role definition for the generative AI model (for example, “You are a professional advertising copywriter”).

Output of this step is a complete prompt sentence (text string) that encodes the original sentence, nuance, and constraints for the generative AI model.

### Step 6:

Server transmits the prompt sentence to the generative AI model via an external API.

Input to this step is the prompt sentence text and model control parameters (for example, temperature, maximum output length).

Server constructs an API request payload including the prompt sentence and model parameters, and adds authentication information such as an access token.

Server then sends the request through the network interface to a model endpoint conforming to a defined protocol (for example, HTTP-based JSON API).

Output of this step is an outbound request toward the generative AI model that encapsulates the prompt sentence and generation parameters.

### Step 7:

Generative AI model, running on external computing infrastructure, receives the request and processes the prompt sentence.

Input to this step is the prompt sentence and the model parameters contained in the request.

Generative AI model tokenizes the prompt sentence into subword tokens, maps the tokens to embeddings, and propagates these embeddings through layers of a transformer-based neural network (including attention layers and feed-forward layers).

Generative AI model computes probability distributions over candidate output tokens at each step, selects tokens according to the configured decoding strategy (for example, sampling or greedy decoding), and generates a sequence of output tokens representing a converted sentence that reflects the specified nuance and style constraints.

Generative AI model then detokenizes the output token sequence into a text string.

Output of this step is converted sentence data (text string) returned in a response message to the server.

### Step 8:

Server receives the response from the generative AI model via the network interface.

Input to this step is the response payload containing the converted sentence text.

Server parses the response, extracts the converted sentence, and performs post-processing operations such as trimming leading and trailing whitespace, removing redundant quotations, and verifying that length and basic style constraints are satisfied.

Server may also apply content filters to detect and correct undesired content if necessary.

Output of this step is a finalized converted sentence text suitable for presentation to the user.

### Step 9:

Server generates output data for the terminal, combining the original sentence data, the selected nuance information, and the finalized converted sentence.

Input to this step is the original sentence, the nuance label, and the post-processed converted sentence.

Server structures this information into a response object and serializes it (for example, into JSON) for network transmission.

Output of this step is a response payload that encapsulates all relevant text data for display.

### Step 10:

Server transmits the response payload to the terminal via the communication network.

Input to this step is the serialized response object generated in the previous step.

Server sends the response through the network interface using the same or a compatible protocol as the request (for example, HTTPS), and associates the response with the initial request context.

Output of this step is an incoming network response at the terminal that contains the converted sentence and related information.

### Step 11:

Terminal receives the response payload and prepares data for display.

Input to this step is the serialized response containing the original sentence, nuance label, and converted sentence.

Terminal deserializes the payload, extracts the converted sentence and optional metadata, and updates the graphical user interface.

Terminal may display the original sentence and the converted sentence side by side, label the applied nuance, and render the text using appropriate fonts and layout.

Output of this step is visual display data presented on the terminal's display device, enabling the user to view the converted sentence.

### Step 12:

Server logs interaction data for learning and system optimization.

Input to this step is the normalized input object (original sentence and nuance label), the generated prompt sentence, and the finalized converted sentence.

Server creates a log record containing these data elements, along with timestamps and identifiers, and stores the record in the storage unit using a structured format (for example, a relational table or document store).

Server may also compute basic statistics (for example, length, punctuation counts, sentiment score) and store them as part of the log.

Output of this step is an updated log dataset that accumulates past input and output data for future analysis.

### Step 13:

Server analyzes accumulated log data to update nuance patterns and style constraint information.

Input to this step is the log dataset containing historical combinations of original sentences, prompt sentences, and converted sentences.

Server processes the dataset using analytical algorithms, such as clustering, feature extraction (for example, n-gram frequency, sentence length distributions), and correlation analysis between nuance labels and output characteristics.

Server then adjusts nuance pattern descriptions and style constraint parameters (for example, modifying instructions about tone or length) based on identified trends, and writes the updated patterns back to the storage unit.

Output of this step is an updated set of nuance patterns and style constraint information that will influence subsequent prompt sentence generation.

### Step 14:

User optionally performs additional conversions based on the displayed result.

Input to this step is the converted sentence displayed on the terminal and the user's subjective evaluation.

User may decide to modify the original sentence, choose a different nuance, or reuse the converted sentence as a new starting point.

Terminal captures the new or modified input from the user and generates a new structured input object.

Output of this step is a new set of sentence data and nuance information, which can be sent again to the server, thereby repeating the processing flow with updated parameters.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional natural language conversion systems that rely on generative artificial intelligence models typically treat prompt generation as a static, application-level operation. In many implementations, an application simply embeds a user-provided sentence into a fixed prompt template and sends the prompt to a generative AI model, without performing detailed linguistic analysis of the input text or without systematically incorporating user-selected expression patterns into the prompt. As a result, such systems often produce outputs whose style, politeness level, or domain appropriateness is inconsistent, and the converted expressions may not reliably match the user's intended nuance. From a computer technology perspective, these systems underutilize available processing resources and model capabilities, because the processor does not structurally analyze the input text or optimize prompt sentences based on accumulated interaction history and feedback data.

Further, conventional systems generally do not maintain fine-grained correspondence information between original texts, expression patterns, and converted texts in a manner that can be exploited by the processor to improve subsequent prompt generation. Without such structured history information and feedback-driven adaptation, the processor cannot effectively learn multiple expression patterns over time, and cannot refine internal control parameters for the generative AI model. This leads to inefficient use of computational resources, repeated generation of suboptimal outputs, and increased latency due to repeated trial-and-error calls to the generative AI model.

Moreover, many existing approaches do not implement server-side mechanisms for dynamically generating multiple candidate prompt sentences for different expression styles, obtaining multiple corresponding converted texts, and selecting, on the processor side, an appropriate converted result for display on a user terminal. In these systems, the selection burden is left entirely to the user or to the external model, and the processor does not function as an intelligent controller that coordinates linguistic analysis, prompt construction, generative processing, and post-processing. Consequently, the overall computing system fails to provide a robust, adaptive pipeline for controlled style conversion in natural language processing.

Accordingly, there is a need for a computer-implemented system in which a processor performs structured validation and normalization of user input, executes linguistic analysis to derive expression attributes, constructs optimized prompt sentences for a generative AI model based on analysis information and user-selected expression patterns, performs post-processing and validation of model outputs, and updates internal templates and constraints using stored history and feedback. By organizing these operations as a coordinated sequence of machine-level processing steps, the underlying computer system can be improved in terms of accuracy, consistency, efficiency, and controllability of expression conversion using a generative AI model.

The specific processing by the specific processing unit 290 of the data processing device 12 in Example 2 is realized by the following means.

The present invention provides a server comprising a processor configured to receive, from a user terminal, an input text and an expression pattern; validate the input text by determining at least a string length and a character type of the input text; normalize the input text; generate input data for prompt generation; perform linguistic analysis on the input data, the linguistic analysis including at least morphological analysis, part-of-speech tagging, dependency parsing, and named-entity extraction, and calculate characteristic values indicating expression attributes of the input text, including at least presence or absence of honorific expressions, whether the input text is a request sentence, and a degree of politeness, thereby generating analysis information indicating the expression attributes of the input text; select, on the basis of the analysis information and the expression pattern acquired from the user terminal, a template of an instruction sentence to be given to a generative AI model; construct a prompt sentence for the generative AI model by incorporating the input text and constraint conditions corresponding to the expression pattern into the template; input the prompt sentence, via an interface, to an external generative AI model or an internal generative AI model; cause the generative AI model to execute a generation process for converting the input text into an expression corresponding to the expression pattern and obtain a converted text as a result of the generation process; perform post-processing on the converted text, the post-processing including at least language type determination, detection of inappropriate terms, and formatting to a predetermined sentence-ending form; generate response data including a post-processed converted text that is outputtable to the user terminal; and store, as history information in a storage device, a correspondence among the input text, the expression pattern, and the converted text, and update at least the template of the prompt sentence and the constraint conditions on the basis of accumulated history information, thereby performing learning of a plurality of expression patterns. This enables the computer system to operate as an improved natural language processing pipeline that adaptively controls prompt sentences and generative AI model behavior, thereby enhancing accuracy, consistency, and efficiency of expression conversion while reducing ineffective model calls and providing stable, style-controlled outputs to the user terminal.

The term “processor” refers to a hardware logic element or a combination of hardware logic elements configured to execute machine-readable instructions, and may include one or more central processing units, graphics processing units, digital signal processors, or other computation units.

The term “user terminal” refers to an information processing apparatus operated by a user for inputting text and receiving converted text, and may include, for example, a mobile communication device, a portable computing device, or a desktop computing device.

The term “input text” refers to a sequence of characters, symbols, or tokens representing natural language content that is supplied from the user terminal to the server and that is a target of expression conversion.

The term “expression pattern” refers to information indicating a desired style, tone, or nuance for converting the input text, and may include, for example, a polite style, an intimate style, or a business style.

The term “validate” refers to processing by which the processor determines whether input data satisfies one or more predetermined conditions, such as length limits, character type constraints, or format requirements.

The term “normalize” refers to processing by which the processor converts an input text into a standardized representation, including at least unifying character forms, adjusting spacing, or removing control characters.

The term “input data for prompt generation” refers to data derived from the input text and suitable for constructing a prompt sentence, including the normalized text and optionally metadata such as the expression pattern.

The term “linguistic analysis” refers to computational processing applied to text for extracting structural and semantic information, and may include at least morphological analysis, part-of-speech tagging, dependency parsing, and named-entity extraction.

The term “morphological analysis” refers to processing by which the processor segments a text into morphemes or tokens and identifies, for each morpheme or token, features such as base form or inflection.

The term “part-of-speech tagging” refers to processing by which the processor assigns, to each token in a text, a grammatical category such as noun, verb, adjective, or particle.

The term “dependency parsing” refers to processing by which the processor determines syntactic dependency relations among tokens in a text, such as modifier-head or subject-predicate relationships.

The term “named-entity extraction” refers to processing by which the processor detects and classifies specific expressions in a text as entities such as persons, organizations, locations, or temporal expressions.

The term “characteristic values” refers to numerical or categorical indicators calculated from analysis results of the input text, and representing attributes such as presence or absence of honorific expressions, sentence type, or degree of politeness.

The term “expression attributes” refers to properties of an input text related to style, tone, or nuance, including at least politeness level, sentence modality, and use of honorific or casual forms.

The term “analysis information” refers to data representing results of linguistic analysis and calculated characteristic values, and indicating expression attributes of the input text.

The term “template of an instruction sentence” refers to a predefined text pattern including fixed wording and one or more insertion portions for variables such as the input text, the expression pattern, or constraint conditions, and used for constructing a prompt sentence.

The term “generative AI model” refers to a computational model using generative artificial intelligence techniques to produce output text in response to input data, and may include, for example, a large language model implemented by a neural network.

The term “prompt sentence” refers to text supplied as input to the generative AI model, the text including an instruction sentence, at least part of the input text, and one or more constraint conditions specifying a requested expression or behavior.

The term “constraint conditions” refers to conditions included in the prompt sentence that limit or specify properties of generated text, such as language, style, length, or prohibition of additional information.

The term “external generative AI model” refers to a generative AI model that is executed on a computing resource outside a local server, and is accessible via a communication interface, such as a network-based application programming interface.

The term “internal generative AI model” refers to a generative AI model that is executed on a computing resource included in or controlled by the server.

The term “interface” refers to a software and hardware arrangement through which the processor exchanges data with a generative AI model, and may include network communication modules, application programming interfaces, or inter-process communication mechanisms.

The term “generation process” refers to processing performed by the generative AI model for converting a prompt sentence into generated text that corresponds to a requested expression pattern.

The term “converted text” refers to text generated by the generative AI model as a result of applying the generation process to the prompt sentence, the text being a transformed version of the input text in accordance with the expression pattern.

The term “post-processing” refers to processing applied to the converted text after generation, including at least language type determination, detection of inappropriate terms, and formatting to a predetermined sentence-ending form.

The term “language type determination” refers to processing by which the processor determines a natural language category of text, such as whether the text is in a first language, a second language, or a mixture.

The term “detection of inappropriate terms” refers to processing by which the processor identifies, within text, words or expressions that are prohibited or undesirable according to predetermined rules or lists.

The term “formatting to a predetermined sentence-ending form” refers to processing by which the processor adjusts a sentence ending of text to conform to a specified pattern, such as a polite final form or a particular punctuation rule.

The term “response data” refers to data generated by the processor for transmission to the user terminal, the data including at least a post-processed converted text and optionally additional metadata.

The term “storage device” refers to a physical or virtual data storage resource, including at least a memory or a non-volatile storage medium, capable of storing history information, templates, or parameter values.

The term “history information” refers to stored data indicating a correspondence among an input text, an expression pattern, a converted text, and optionally evaluation information or processing context.

The term “learning of a plurality of expression patterns” refers to processing by which the processor updates one or more internal resources, such as templates or constraint conditions, based on accumulated history information or feedback, to improve handling of multiple expression styles.

The term “evaluation information” refers to data representing a quality assessment of a conversion result, the data being obtained from the user terminal and associated with a particular input text, expression pattern, and converted text.

The term “generation parameter” refers to a parameter controlling behavior of a generative AI model during the generation process, including at least a temperature, a maximum output length, or a randomness setting.

The term “expression style” refers to a specific manner of expression in text, characterized by attributes such as politeness, formality, or intimacy, and may include at least a polite style, an intimate style, and a business style.

The term “polite style” refers to an expression style in which text is formulated using honorific or formal forms suitable for respectful communication.

The term “intimate style” refers to an expression style in which text is formulated in a casual or familiar tone suitable for communication among close associates.

The term “business style” refers to an expression style in which text is formulated using terminology and politeness appropriate for professional or commercial communication.

The term “dynamically generate” refers to processing by which the processor constructs one or more prompt sentences at runtime based on current input text, expression pattern, and internal state, rather than relying solely on fixed, static prompt sentences.

The term “select a converted text to be displayed” refers to processing by which the processor chooses, from among a plurality of converted texts generated by the generative AI model, a particular converted text for output to the user terminal.

In one embodiment, the server operates on a general-purpose computing platform such as a rack-mounted computer system including at least one central processing unit, a main memory, a non-volatile storage device, and a network interface. The server executes an operating system and application software implemented, for example, using a programming language runtime and a web application framework. The server communicates with the terminal via a packet-based communication network such as the Internet, using a secure communication protocol.

The terminal operates as a user-facing information processing apparatus such as a portable computing device or a stationary computing device. The terminal executes a web browser or a native application that provides a graphical user interface. The terminal displays an input area for the user to enter an input text and a control for the user to select an expression pattern, such as a polite style, an intimate style, or a business style. The user operates the terminal to input the input text and to specify the desired expression pattern, and the terminal transmits corresponding data to the server via the network interface.

The server stores, in the non-volatile storage device, program modules and data structures for implementing prompt construction, linguistic analysis, model interaction, post-processing, and learning control. The server stores, for example, an expression pattern table holding records for each expression pattern. Each record includes at least a pattern identifier, a description, an example expression style, and one or more prompt templates that define skeleton forms of instruction sentences for a generative AI model. The server further stores a history database, which records correspondences among input texts, expression patterns, converted texts, and evaluation information. The server additionally stores configuration parameters for a transformer-based generative AI model, such as a model identifier, a maximum number of tokens, and generation parameters including temperature and top-k or top-p sampling thresholds.

The server uses a natural language processing library loaded into main memory, which provides functions for morphological analysis, part-of-speech tagging, dependency parsing, and named-entity extraction. The server applies these functions to the input text for the purpose of generating analysis information. The server processes the input text as a sequence of code points, converts the sequence into tokens, and stores the tokens in a language-specific token array. The server associates, with each token, a part-of-speech tag and dependency attributes, and stores this information in a token annotation structure.

The server calculates characteristic values such as a politeness score, a sentence type classification, and binary flags indicating presence or absence of honorific expressions. The server calculates the politeness score by referencing a lexicon of polite expressions and by counting morphological forms associated with honorific or humble expressions. The server normalizes the score to a numerical value in a predetermined range. The server determines whether the input text is a request sentence by analyzing the sentence-ending tokens and matching them against predefined patterns such as forms corresponding to requests or inquiries. The server represents these characteristic values in an analysis information structure.

The server selects a prompt template based on the expression pattern and the analysis information. The server, for example, selects a template that emphasizes increased politeness when the analysis information indicates that the input text is already somewhat polite but must be converted into a highly polite style. The server inserts the input text and constraint conditions into the selected template to form a prompt sentence. The server thereby constructs prompt sentences that more precisely control the behavior of the generative AI model than conventional fixed prompt usage.

In one example, the server constructs the following prompt sentence for a polite style:
“You are an assistant that rewrites Japanese text.
Convert the following sentence into a more polite expression in Japanese, without changing the meaning.
Sentence: ‘Please tell me the meeting time.’
Constraints: Do not add any new information. Output only one polite Japanese sentence.”

In another example, the server constructs the following prompt sentence for a casual or intimate style:
“You are an assistant that rewrites Japanese sentences into a casual tone.
Please rewrite the following sentence into a casual expression like a conversation between friends.
Sentence: Please tell me the meeting time
Constraint: Without changing the meaning, output only one sentence.”

In a further example, the server constructs the following prompt sentence for a business style:
“You are an assistant that creates business email sentences.
Please rewrite the following sentence into an appropriate polite expression for a business email to an external recipient.
Sentence: Please send the quotation as soon as possible.
Constraint: Output only one polite request sentence using honorific language.”

The server represents each prompt sentence internally as a character string, and, in some embodiments, also as a sequence of tokens after applying a tokenizer consistent with the generative AI model. The server constructs an API request object containing at least the prompt sentence, model identifier, and generation parameters. The server then transmits this object via the network interface to a remote computing system implementing the generative AI model, or to a local model runtime in the case of an internal model.

The generative AI model is implemented as a multi-layer transformer neural network having an input embedding layer, a plurality of self-attention layers, and an output projection layer. The model includes learned weight matrices for query, key, and value projections in each attention head, as well as layer normalization parameters. During inference, the model receives tokenized representations of the prompt sentence and computes, in the attention layers, weighted sums of value vectors based on similarity scores derived from query and key vectors. The model then produces a probability distribution over the token vocabulary for each output position. The server controls aspects of the generative process by setting parameters such as temperature, which scales the logits before the softmax operation, and a maximum token count, which limits the length of the converted text.

The server obtains, as a response, a converted text from the generative AI model. The server checks that the converted text is properly encoded and not empty, and stores it temporarily in main memory. The server applies post-processing operations that include language type determination, detection of inappropriate terms, and formatting to a predetermined sentence-ending form. The server, for example, determines that the converted text is in a target language by inspecting character categories and language-specific patterns. The server detects inappropriate terms by scanning the converted text against a table of disallowed expressions and, if necessary, replacing or rejecting outputs that contain such expressions.

The server adjusts sentence endings so that, for a polite style, the text ends with a polite verb form and proper punctuation.

The server generates response data containing the post-processed converted text and additional metadata, such as an identifier of the expression pattern and an identifier of the processing instance. The terminal receives the response data and updates the user interface to display the converted text to the user. The user can then review the converted text and optionally provide evaluation information indicating whether the conversion result is satisfactory.

The server stores, in the history database, a record associating the input text, the expression pattern, the converted text, and, when available, the evaluation information. The server uses this history information to update prompt templates and constraint conditions. The server, for instance, analyzes distributions of politeness scores and user evaluations over time to adjust which template should be selected for a given pattern and analysis result. The server may lower a temperature parameter or tighten constraint wording when history indicates that the generative AI model tends to deviate from the desired style under certain conditions. This adaptive adjustment improves the accuracy and consistency of expression conversion over a large number of interactions.

In some embodiments, the server generates multiple prompt sentences for the same input text but for different expression styles. The server sends these prompt sentences to the generative AI model and obtains multiple converted texts. The server compares characteristic values calculated on each converted text, such as length, politeness indicators, and presence of ambiguous terms, and selects a converted text having properties most consistent with system-defined criteria. The terminal then displays the selected converted text, and may additionally offer alternative converted texts to the user for comparison. This server-side selection mechanism reduces the cognitive load on the user and contributes to a more efficient overall processing pipeline.

The server, by executing these coordinated operations, achieves technical effects beyond mere automation of human rewriting. Because the server performs normalization, structured linguistic analysis, and template selection before contacting the generative AI model, the server reduces the likelihood of misaligned or irrelevant outputs, thereby reducing the number of repeated model calls and lowering network traffic and processing time. The server's use of characteristic values and expression attributes functions as a pre-filter that shapes the input space for the generative AI model, leading to more stable and predictable behavior.

The server also improves data management by storing structured history information and evaluation data in a manner keyed by expression pattern and input characteristics. The server exploits this structure to refine prompt templates and generation parameters using explicit rules. For example, the server identifies combinations of pattern and politeness score that frequently generate user-rejected outputs and adjusts prompt wording or parameters specifically for those combinations. This rule-based adaptation, driven by structured history, constitutes a technical improvement to computer operation: the server learns which internal settings are more likely to produce acceptable outputs for given categories of input, thereby decreasing error rates over time.

In contrast to human rewriting, the server enforces non-human rules such as deterministic validation thresholds, specific token-based politeness scoring methods, and grammar-consistent sentence-ending transformations. When the server determines that a converted text violates one of these rules, the server can automatically request a revised generation using a modified prompt sentence that strengthens relevant constraints. This closed-loop control mechanism between analysis, prompt adjustment, and model invocation leads to a more robust and efficient utilization of computing resources.

In another embodiment, the server hosts an internal generative AI model on a specialized computation unit such as a graphics processing unit. The server uses a minibatch inference technique to process multiple prompt sentences concurrently, thereby improving throughput.

The server arranges tokens from multiple prompts into a batched tensor, performs matrix multiplications and attention operations using the graphics processing unit, and returns separate converted texts to the calling modules. By batching requests and by dynamically adjusting maximum token lengths based on analysis information, the server reduces unnecessary computation and improves overall system performance.

In some variations, the server employs different neural network configurations for different expression patterns. For example, the server may use a smaller model for simple polite conversions and a larger model for complex business style transformations. The server decides which model to use by referencing the analysis information, such as domain-specific token counts or grammatical complexity. This model selection strategy results in reduced latency and resource consumption for simpler tasks, while preserving quality for more demanding conversions.

The terminal, by implementing efficient user interface operations, further contributes to technical advantages. The terminal can cache frequently used expression patterns and display them without repeated retrieval from the server. The terminal can also enforce basic validation, such as input length checks, before transmitting data, thereby avoiding unnecessary network traffic. When combined with server-side optimization, this arrangement leads to reduced communication load and improved responsiveness of the entire system.

The user interacts with the system by entering input texts and reviewing converted texts, but the technical improvements arise from the way in which the server and terminal cooperate to implement structured analysis, adaptive prompt generation, controlled interaction with a transformer-based generative AI model, and feedback-driven refinement. The described embodiments therefore provide a concrete implementation of a natural language expression conversion system that improves computer technology itself, including more efficient use of processing resources, better data organization, and more accurate and consistent transformation of language expression by means of a generative AI model and prompt sentences.

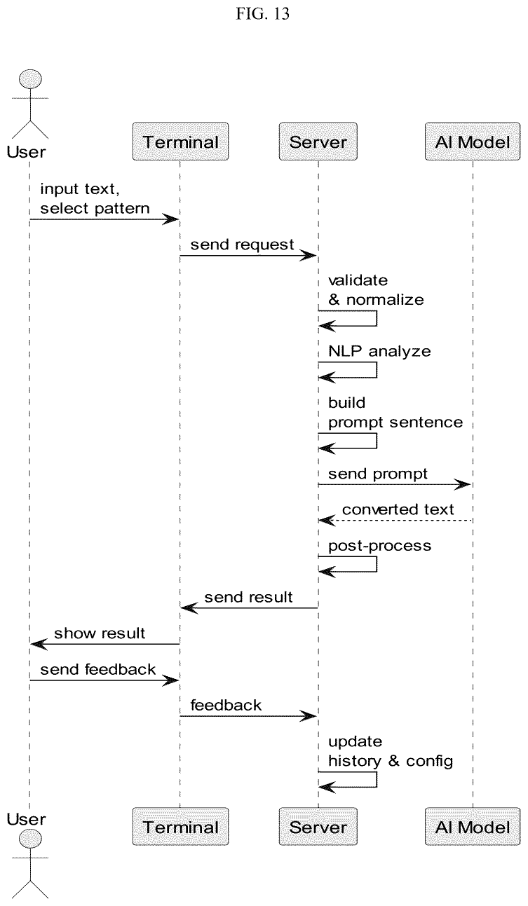

The following describes the processing flow using FIG. 13.

### Step 1:

The user operates the terminal to launch an application and display an input screen.

The terminal displays a text input field and a list of expression patterns such as polite style, intimate style, and business style.

The user inputs an input text (input: raw character string) and selects an expression pattern (input: pattern identifier).

The terminal validates the input length and character type by comparing the input text against preset limits and allowed character ranges, and the terminal outputs a validated request object including the input text and the expression pattern.

### Step 2:

The terminal transmits the validated request object to the server via a network interface using a secure communication protocol.

The server receives the request (input: request object containing input text, expression pattern, and session information) and parses the object using a request handler.

The server performs server-side validation by checking that mandatory fields exist and that the expression pattern matches a registered pattern key, and the server outputs a normalized input record stored temporarily in main memory.

### Step 3:

The server executes a normalization process on the input text (input: raw input text from the normalized input record).

The server converts variant character forms to standard forms, removes control characters, unifies spaces, and trims leading and trailing whitespace by applying string transformation functions.

The server outputs a normalized text string and updates the normalized input record with the normalized text.

### Step 4:

The server performs linguistic analysis on the normalized text (input: normalized text string).

The server invokes a natural language processing module to execute morphological analysis, part-of-speech tagging, dependency parsing, and named-entity extraction.

The server constructs a token list and an annotation structure that associates each token with grammatical and dependency information, and the server calculates characteristic values such as politeness score, request-sentence flag, and honorific-usage flag by inspecting token annotations.

The server outputs analysis information as a structured data object containing the token list, annotations, and characteristic values.

### Step 5:

The server selects an expression pattern definition (input: pattern identifier and analysis information).

The server queries an expression pattern table stored in a storage device to obtain a pattern record including description, target style, and one or more prompt templates.

The server evaluates the analysis information, such as the politeness score and sentence type, to choose a suitable prompt template for the requested expression pattern.

The server outputs a selected prompt template and a set of constraint conditions derived from the pattern record and the analysis information.

### Step 6:

The server constructs a prompt sentence for a generative AI model (input: normalized text, selected prompt template, and constraint conditions).

The server inserts the normalized text into a designated placeholder in the template and appends explicit constraints such as “do not add new information” or “output a single sentence,” by concatenating text fragments.

The server generates a complete prompt sentence string that encodes the instruction, the original sentence, and the constraints, and the server outputs this prompt sentence as a character string ready for model input.

### Step 7:

The server prepares a model request for the generative AI model (input: prompt sentence and model configuration parameters).

The server tokenizes the prompt sentence using a tokenizer compatible with the generative AI model, converts tokens into numerical IDs, and packages them into a model input structure including model identifier, temperature, and maximum token count.

The server outputs a model request object suitable for transmission via an application programming interface.

### Step 8:

The server sends the model request to a generative AI model runtime (input: model request object).

The server transmits the model request via a network interface to an external model service or to a local model process.

The generative AI model executes a generation process consisting of embedding lookup, multiple layers of self-attention and feedforward computation, and output projection to vocabulary probabilities, and the model outputs a sequence of token IDs representing a converted text.

The server receives the model response, decodes the token IDs into a converted text string, and outputs the converted text as a raw model output.

### Step 9:

The server executes post-processing on the converted text (input: raw converted text).

The server performs language-type determination by inspecting character ranges and language-specific patterns, performs detection of inappropriate terms by scanning the text against a prohibited-word list, and performs formatting to enforce a predetermined sentence-ending form appropriate for the requested style.

The server may replace or remove inappropriate segments and adjust punctuation or verb endings to match style rules.

The server outputs a post-processed converted text that satisfies internal format and safety constraints.

### Step 10:

The server generates response data for the terminal (input: post-processed converted text and processing metadata).

The server constructs a response object including the converted text, the expression pattern identifier, and a request identifier, and serializes the object into a format suitable for network transmission.

The server outputs the serialized response data and transmits it to the terminal via the network interface.

### Step 11:

The terminal receives the response data from the server (input: serialized response data).

The terminal deserializes the response data into a structured object and extracts the post-processed converted text and related metadata.

The terminal updates the user interface by displaying the converted text in an output area, optionally together with the original input text for comparison.

The terminal outputs a visual representation of the converted text on the display, enabling the user to inspect the result.

### Step 12:

The user reviews the converted text as displayed on the terminal (input: displayed converted text).

The user determines whether the converted text matches the intended expression pattern and nuance.

The user optionally provides evaluation information, such as selecting that the result is satisfactory or unsatisfactory, and the terminal captures this evaluation as feedback data.

The terminal outputs a feedback object containing the evaluation information, the request identifier, and references to the original and converted texts.

### Step 13:

The terminal transmits the feedback object to the server (input: feedback object).

The server receives the feedback, associates it with stored history for the corresponding request, and updates a history record that includes the input text, the expression pattern, the converted text, and the evaluation information.

The server outputs an updated history database entry stored in a storage device.

### Step 14:

The server analyzes accumulated history information (input: multiple history records including inputs, patterns, outputs, and evaluations).

The server computes statistics over expression patterns, politeness scores, model parameters, and evaluation labels using data aggregation operations.

The server identifies combinations of pattern and analysis conditions that frequently produce unsatisfactory results and adjusts prompt templates, constraint wording, and model generation parameters by updating configuration entries.

The server outputs updated template definitions and parameter settings that will be used in subsequent executions of prompt construction and model invocation.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional text transformation systems that utilize generative artificial intelligence models typically accept a user's input text and a coarse style designation, and then directly forward this information to a generative model. Such systems generally treat the generative model as a black-box text rewriter and do not perform structured pre-processing of the input text, fine-grained selection or adjustment of style patterns based on emotional context, or systematic post-processing of the model output. As a result, several technical problems arise in the operation of computer-implemented text conversion pipelines.

First, conventional systems are prone to unstable and inconsistent outputs because they lack explicit intermediate representations describing nuance patterns, constraints, and emotional categories. Without a structured pipeline in which a processor analyzes syntax and semantics, detects emotion, and maps these results to a well-defined nuance pattern prior to prompt construction, small variations in input or model behavior can cause large and unpredictable changes in output style. This instability complicates downstream rendering, caching, and reuse of converted text within content delivery systems.

Second, existing approaches often cannot continuously adapt nuance patterns to actual usage because they do not incorporate a feedback-driven learning mechanism at the system level. In many implementations, style guidance is hard-coded in the prompt, and the server does not extract or update nuance patterns from accumulated input-output data. As a consequence, the system cannot systematically refine its internal style models, cannot efficiently manage a large set of nuanced behaviors, and cannot reliably align the generative model's behavior with application-level constraints such as subtitle length budgets, politeness levels, or domain-specific vocabularies.

Third, computer systems that deliver subtitles, explanatory texts, and response texts in real time or quasi real time for multimedia content face strict latency and determinism requirements. Conventional generative-model integration often issues ad-hoc prompts per request without standardized pre- and post-processing, leading to inefficiencies in CPU and memory usage and to irregular response times. In particular, for streaming video or audio content, naive integration of a generative model can cause missed subtitle display windows, jitter in text updates, or overload of processing resources due to redundant or unstructured calls.

Fourth, many existing systems do not systematically combine emotion analysis with nuance pattern selection and post-processing. They may either ignore detected emotion or embed emotion information directly into the prompt in an unstructured manner. This lack of a layered architecture—where a processor first computes an emotion category, then explicitly selects or adjusts a nuance pattern, then constructs a prompt sentence, and finally applies rule-based post-processing—limits control over the generative model. As a result, the system may produce outputs that violate length or vocabulary constraints imposed by the rendering context, require manual correction, or fail to meet the communicative intent of the user.

Accordingly, there is a need for an improved computer-implemented system and processing pipeline that: (i) structurally decomposes the generative text conversion task into analysis, pattern selection, prompt construction, generative inference, and post-processing stages; (ii) maintains and updates a plurality of nuance patterns via machine learning on past data; (iii) integrates emotion analysis into the selection or adjustment of nuance patterns; and (iv) supports efficient, real-time or quasi real-time delivery of converted text such as subtitles on user terminals, with explicit enforcement of length, vocabulary, and prohibited-expression constraints. Such a system would improve stability, predictability, and resource efficiency of generative-model-based text conversion on computing devices and networks.

The specific processing by the specific processing unit 290 of the data processing device 12 in Application Example 2 is realized by the following means.

The present invention provides a server comprising a processor configured to receive, from a terminal, character information and a nuance category, to execute natural language processing on the character information to obtain syntactic and semantic analysis results, to execute emotion analysis on the character information to obtain an emotion category and an emotion intensity, to select or adjust a nuance pattern including at least a representation style, a writing style, and a length constraint on the basis of the emotion category and the nuance category, to construct a prompt sentence on the basis of the analysis results, the nuance pattern, and the character information, the prompt sentence instructing a generative AI model to generate or transform character information having a predetermined nuance, to input the prompt sentence to the generative AI model and obtain transformed character information having the predetermined nuance, to perform post-processing on the transformed character information on the basis of at least one of the length constraint, a vocabulary constraint, and a prohibited-expression constraint to generate display character information, and to transmit the display character information to the terminal so that the display character information is output as at least one of a subtitle, an explanatory text, and a response text of content. This enables a structured, multi-stage text conversion pipeline in which the server stably controls the behavior of the generative AI model, adaptively manages a plurality of nuance patterns learned from past data, combines emotion-aware pattern selection with deterministic post-processing, and efficiently delivers real-time or quasi real-time converted text to user terminals under explicit computational and rendering constraints, thereby improving the overall performance and reliability of the computer-implemented text transformation system.

The term “processor” refers to an information processing unit, including one or more central processing units or hardware logic circuits, that executes computer-readable instructions to perform the functions described in the claims.

The term “terminal” refers to an information processing apparatus operated by a user, such as a computing device having an input interface and a display interface, that sends character information and related parameters to the server and receives display character information from the server.

The term “character information” refers to digital text data composed of one or more characters, symbols, or strings, including sentences, phrases, and subtitles, that is input by a user or obtained from content and that is subject to analysis and transformation.

The term “nuance category” refers to a classification label indicating a desired style, tone, or expressive quality of character information, such as calm, polite, casual, or concise, which is used as a parameter for selecting or adjusting a nuance pattern.

The term “nuance pattern” refers to a structured set of style parameters, including at least a representation style, a writing style, and a length constraint, that defines how character information is to be transformed to express a specific nuance.

The term “representation style” refers to a group of style constraints that specify how concepts, emotions, and intentions are expressed in character information, including selection of expressions, degree of emphasis, and strength of emotional wording.

The term “writing style” refers to a group of stylistic parameters that define formality level, sentence structure, and linguistic conventions of character information, such as formal or informal, polite or casual, verbose or succinct.

The term “length constraint” refers to a restriction defining a permissible size of character information, including a maximum number of characters, a maximum number of tokens, or a maximum number of lines, that is applied during or after transformation.

The term “natural language processing” refers to computerized analysis of character information using linguistic techniques, including at least one of tokenization, sentence segmentation, part-of-speech tagging, syntactic parsing, semantic analysis, and key phrase extraction.

The term “syntactic analysis” refers to processing that identifies grammatical structure of character information, including relationships among words, such as subjects, predicates, and modifiers.

The term “semantic analysis” refers to processing that determines meanings, roles, and relations of terms and phrases in character information, including extraction of topics, entities, and semantic roles.

The term “emotion analysis” refers to processing that detects emotional states or sentiments expressed in character information, and that outputs at least an emotion category and optionally an emotion intensity.

The term “emotion category” refers to a classification label indicating a type of detected emotion, such as positive, negative, or neutral, or more specific categories such as joy, anger, or sadness, used for nuance pattern selection or adjustment.

The term “emotion intensity” refers to a quantitative or ordinal measure indicating the strength or degree of a detected emotion in character information.

The term “prompt sentence” refers to an instruction text constructed by the processor that includes at least a representation of a nuance pattern, analysis results, and original character information, and that is supplied to a generative AI model to control generation or transformation of character information.

The term “generative AI model” refers to a machine learning model that receives a prompt sentence as input and generates or transforms character information by performing probabilistic computations, such as a neural network-based language model.

The term “transformed character information” refers to character information output by the generative AI model in response to the prompt sentence, the character information having been modified to reflect a predetermined nuance defined by a nuance pattern.

The term “vocabulary constraint” refers to a restriction specifying allowable or preferred words or phrases, or disallowing certain terms, that is applied during or after transformation of character information.

The term “prohibited-expression constraint” refers to a restriction specifying words, phrases, or expression types that must not appear in the transformed character information or display character information.

The term “post-processing” refers to processing that is applied to transformed character information after generation by the generative AI model, including at least one of trimming, reformatting, enforcing length constraints, applying vocabulary constraints, and removing prohibited expressions.

The term “display character information” refers to character information that has been transformed and post-processed and that is ready to be output on a display device of the terminal as a subtitle, explanatory text, or response text.

The term “subtitle” refers to display character information that is temporally associated with video or audio content and that is superimposed or otherwise presented in synchronization with the content as textual representation.

The term “explanatory text” refers to display character information that provides description, explanation, or commentary related to content or user interaction.

The term “response text” refers to display character information that is used as a reply or message in an interactive communication scenario, including dialogue, chat, or transaction support.

The term “content” refers to digital media data, including at least one of video data, audio data, image data, and associated metadata, with which character information such as subtitles, explanatory text, or response text is correlated.

The term “past input-output data” refers to accumulated records containing at least original character information, context parameters, and corresponding transformed character information, which are used as training data for machine learning to extract or update nuance patterns.

The term “machine learning” refers to computerized training procedures in which model parameters or pattern representations are adjusted based on past input-output data so as to improve selection, adjustment, or application of nuance patterns.

The term “real time” refers to processing in which character information is transformed and delivered with latency sufficiently low that the transformed character information is available substantially simultaneously with ongoing reproduction of corresponding content.

The term “quasi real time” refers to processing in which character information is transformed and delivered with latency that is not strictly instantaneous but is short enough to allow practical use during or shortly after ongoing reproduction of corresponding content.

The term “superimpose and display” refers to a display operation in which display character information is visually overlaid or composited on a screen region presenting video or other content so that the character information appears in association with the content.

In one embodiment, a system includes a server and a terminal connected via a communication network. The server includes at least one processor, a main memory, a non-volatile storage device, and a network interface implemented on general-purpose computer hardware, such as an instruction-set-based processor, a memory controller, and a network controller. The terminal includes a processing unit, a display, an input interface, and a communication interface, and is implemented, for example, as a smartphone, a tablet device, a personal computer, or a head-mounted display device.

Server executes an operating system and middleware, and runs application software implemented, for example, in a programming language runtime. Server loads from non-volatile storage a plurality of software modules, including at least: a request reception module, a natural language processing module, an emotion analysis interface module, a nuance pattern management module, a prompt construction module, a generative AI model interface module, a post-processing module, and a response transmission module. Server further stores in a storage region a plurality of nuance patterns, each nuance pattern being associated with style parameters and constraint parameters, and stores a trained generative AI model configuration accessed through a model provider interface.

Terminal executes a user-facing application that provides a graphical user interface. Terminal displays an input area for character information and a selection interface for a nuance category, such as “calm tone,” “very polite wording,” “casual youth style,” or “concise explanation.” Terminal transmits, through the communication interface, character information input by a user and a nuance category selected by the user to the server as structured data, and receives display character information from the server to be rendered as subtitles, explanatory text, or response text on the display. Terminal may additionally acquire character information from content metadata, such as subtitles bundled with video streams, and may automatically forward such character information, with or without user editing, to the server.

Server implements the natural language processing module using a language processing library, such as a tokenizer, a part-of-speech tagger, and a syntactic parser. Server loads a pre-trained language model, for example an English or Japanese model, into main memory, and applies the model to input character information. Server converts the input character sequence into an internal token sequence using a deterministic tokenization algorithm, annotates each token with part-of-speech tags and syntactic dependencies, and builds a dependency tree representation stored in a structured object in memory. Server further derives a semantic role representation, such as agent, patient, and predicate, and stores this semantic metadata in association with the input character information.

Server implements the emotion analysis interface module as a client to an emotion analysis engine. Server transmits the input character information to the emotion analysis engine through a network interface using a structured request, and receives as a response an emotion vector, including an emotion category and an emotion intensity. Server converts the received emotion vector into a compact representation, for example a fixed-length array of floating-point values or normalized scores, and stores this representation in memory. Server may, in an alternative embodiment, execute an on-premise emotion classification model built as a neural network using a machine learning framework; in such a case, server converts the token sequence of the input character information into embeddings, passes the embeddings through recurrent or transformer layers, and applies a softmax classifier layer to output a probability distribution over emotion categories.

Server implements the nuance pattern management module as a component that stores nuance patterns in a database or a key-value store. Each nuance pattern includes a representation style, a writing style, and a length constraint, and may also include vocabulary preferences and prohibited expression lists. Server represents each nuance pattern as a structured record, for example a map from parameter names to numerical values and discrete labels. Server maintains a plurality of nuance patterns, such as patterns corresponding to calm tone, highly polite tone, casual tone, and concise tone, and stores weight vectors or rule sets that define how each pattern modifies linguistic features. Server further updates the nuance patterns using machine learning based on past input-output data, by computing feature differences between input and desired output, and adjusting pattern parameters to minimize an objective function.

Server implements the prompt construction module to generate a prompt sentence that is supplied to a generative AI model. Server receives the analysis result from the natural language processing module, the emotion category and intensity from the emotion analysis interface module, and the selected or adjusted nuance pattern from the nuance pattern management module. Server combines these elements into a unified representation of the target style, including desired formality, emotional strength, target length, and lexical constraints. Server then constructs a prompt sentence as a text string that encodes this representation in natural language instructions understandable by the generative AI model.

Server stores one or more prompt templates in non-volatile storage, each template including placeholders for nuance pattern labels, language labels, and original character information.

Server replaces the placeholders with actual values to form a prompt sentence. For example, server may generate a prompt sentence such as:
“Please convert the following sentence into a calm way of speaking: ‘He shouted in anger.’”
or
“Based on the nuance pattern ‘very polite wording’, rewrite the following sentence while preserving its original meaning: ‘Thank you.’”
or
“When the user's emotion is positive and the audience is young people, convert the following sentence into a casual youth style: ‘This product is excellent.’”

Server may add explicit constraints in the prompt sentence, such as:
“Keep the original meaning, do not add new information, and limit the output to one short sentence.”

By incorporating length and vocabulary constraints into the prompt sentence, server ensures that downstream post-processing can operate more deterministically and requires fewer corrections.

Server implements the generative AI model interface module as a client component that communicates with a generative AI model through a network endpoint or, in another embodiment, through a local inference engine. In one embodiment, the generative AI model is a transformer-based neural network language model characterized by an embedding layer, a plurality of self-attention layers, and a final projection layer. Server encodes the prompt sentence into tokens using the generative AI model's tokenizer, and passes the resulting token sequence along with generation parameters such as temperature, maximum output length, and top-k or nucleus sampling thresholds to the generative AI model.

Generative AI model internally computes contextualized vector representations for each token using multi-head self-attention mechanisms and feed-forward sublayers. Generative AI model iteratively generates new output tokens conditioned on the prompt sentence and previously generated tokens, terminating when an end-of-sequence token or a length limit is reached. Server receives the sequence of generated tokens and decodes the tokens into a transformed character sequence, which represents transformed character information having the predetermined nuance defined by the nuance pattern.

Server implements the post-processing module to adjust the transformed character information according to constraint parameters. Server measures the length of the transformed character information, in characters or tokens, and cuts or splits the sequence if it exceeds the length constraint. Server scans the transformed character information for terms that violate vocabulary constraints or prohibited-expression constraints. Server replaces disallowed terms using a substitution table or requests a regeneration with modified parameters if unacceptable content is detected. Server may, in some embodiments, apply a rule-based grammar check or run an additional lightweight language model to ensure that concatenation or truncation has not introduced obvious errors.

Server generates display character information by encapsulating the cleaned, constrained transformed character sequence along with timing and positioning metadata. For subtitle applications, server attaches timecodes corresponding to content playback positions and specifies layout parameters such as line breaks and maximum number of characters per line.

Server transmits the display character information to the terminal over the network, using a protocol designed for streaming or batched updates.

Terminal receives the display character information and merges it into a local subtitle or text display buffer. Terminal uses a rendering engine to superimpose the display character information on video or audio content, ensuring that font, color, and positioning meet usability constraints. Because server has enforced length and constraint rules, terminal can perform simple, deterministic drawing operations without complex run-time adjustments, thereby reducing processing overhead on the terminal.

User perceives the technical improvement because subtitles and other texts are converted into a desired nuance in real time or quasi real time without flickering, truncation artifacts, or inconsistent phrasing. In particular, by structuring the server pipeline into analysis, pattern selection, prompt construction, generative inference, and post-processing, and by explicitly using internal data structures for nuance patterns and constraints, the system reduces the variability inherent in directly issuing unstructured prompts to a generative AI model. This results in reduced error rates in meeting length limits and prohibited expression constraints, and in reduced need for manual correction.

Server improves computing performance relative to naive generative-model integration by caching analysis results and nuance pattern selections for repeated or similar inputs, by optimizing prompt sentences to minimize unnecessary tokens, and by enforcing constraints through deterministic post-processing rather than repeated full model calls. Server thereby reduces network bandwidth consumption to the generative AI model endpoint and lowers average latency per request. Additionally, because nuance patterns are stored as parameterized records and are updated via machine learning, server can refine style control without retraining the entire generative AI model, which reduces computation required for deployment and maintenance.

Server implements the machine learning procedure for nuance pattern updates using a neural network or other parametric model trained on past input-output data. Server defines a feature extractor that maps input character information and target transformed character information into feature vectors that capture, among other aspects, differences in sentence length, verb formality, lexical choice, and emotional intensity. Server defines a loss function, such as mean squared error between predicted and observed style features, or cross-entropy between predicted and manually labeled nuance categories. Server updates the parameters of the nuance pattern model by performing gradient descent or a related optimization algorithm, adjusting the pattern weights stored in the nuance pattern management module. By controlling nuance conditioning in a separate layer from the main generative AI model, server reduces the complexity of model updates and allows nuanced control to be improved with lower compute cost.

Server distinguishes from simple automation of human editing by employing a non-conventional dataflow and rule set specific to machine computation. A human editor would typically read and rewrite sentences directly based on intuitive understanding, while server decomposes the task into: (i) formal syntactic and semantic analysis using machine-readable structures, (ii) quantification of emotional content via emotion vectors, (iii) selection or adjustment of nuance patterns based on numeric thresholds and learned mappings, (iv) encoding of these decisions into a prompt sentence designed to drive a specific transformer architecture, and (v) deterministic enforcement of length and vocabulary constraints through algorithmic post-processing. This architecture is tailored to the characteristics of neural text generation systems and exploits machine-specific capabilities, such as vectorized emotion representation and automated constraint checking, that are not natural operations in manual workflows.

Server, by combining these modules, achieves technical effects including increased accuracy of matching target length and style constraints, reduced computational load on the terminal, and improved stability in network resource usage. Because prompt sentences are constructed from structured templates with limited variability, server reduces token length and thus computational cost inside the generative AI model. Because emotion analysis and nuance pattern selection are performed once per input and re-used for prompt construction, server avoids redundant computations. Because post-processing operates on already generated text with linear-time scanning algorithms, it can efficiently enforce constraints without further high-cost inference calls.

In another embodiment, server hosts the generative AI model locally using a machine learning framework. Server loads a transformer network architecture that includes an embedding matrix, multiple self-attention layers, residual connections, layer normalization blocks, and a final linear output layer. Server stores learned weights obtained from prior training on large corpora. Server implements inference by performing matrix multiplications and non-linear activation operations on hardware accelerators such as graphics processing units. By controlling attention mask configurations and limiting maximum context length according to prompt design, server reduces computation per request. The prompt construction module is specifically designed to minimize unnecessary context, thereby improving throughput of the generative AI model and allowing more concurrent user requests to be served using the same hardware resources.

In yet another embodiment, server integrates a local rule-based fallback engine that operates when network access to an external generative AI model endpoint is degraded. In this case, server applies deterministic transformation rules derived from nuance patterns, such as verb replacement tables for politeness, sentence shortening heuristics for concise style, or adjective substitution lists for calm tone. Although such rules may produce less nuanced results than the generative AI model, they ensure continuity of service and maintain adherence to basic length and prohibited expression constraints.

In a further embodiment, server manages multiple versions of nuance patterns and allows deployment of variant configurations for different content types or terminals. For example, server may maintain a subtitle-optimized nuance pattern that strongly emphasizes length constraints and readability, and a chat-optimized nuance pattern that allows more expressive and longer outputs. Server stores these variants in a configuration store and selects an appropriate pattern based on content type metadata sent by the terminal. By tailoring nuance pattern parameters to device capabilities and content usage, server reduces rendering errors and improves user experience.

User, by interacting only with the terminal, is shielded from internal complexity and can select desired nuance categories with simple operations. Nevertheless, the system internally leverages structured data representations, neural network inference, and deterministic rule enforcement to transform character information in a manner that improves technical behavior of the computing environment, including reduced latency for real-time subtitles, predictable resource consumption on servers and terminals, and improved compliance with programmatic constraints on output character information.

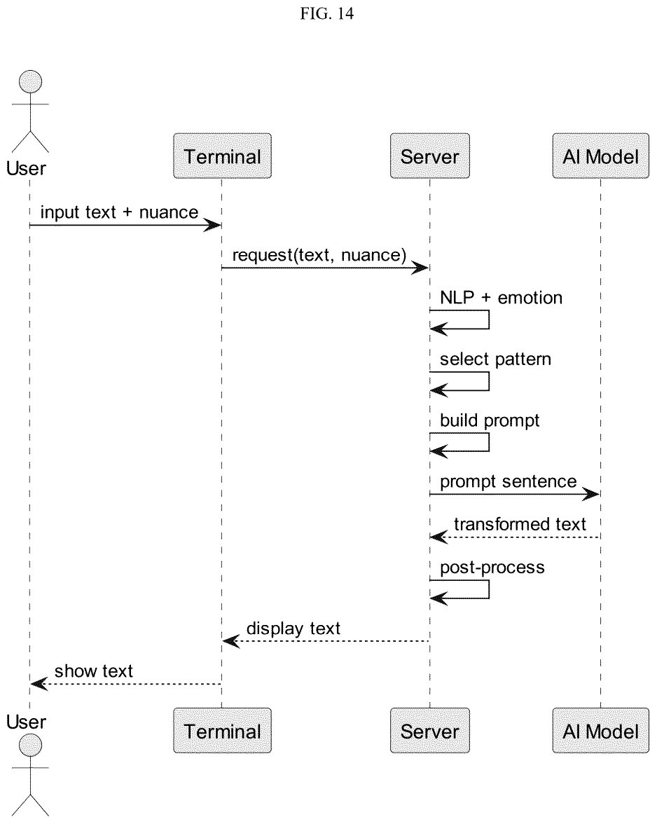

The following describes the processing flow using FIG. 14.

### Step 1:

User operates the terminal to input original character information and select a nuance category.

User enters a text string, such as “He shouted in anger.”, into an input field on the terminal, and selects a nuance category, such as “calm tone” or “very polite wording”, from a list or menu. The input of this step is user-generated character information and a selected nuance category. The output of this step is a structured set of user parameters, including the text string, the nuance category, and optional metadata such as language and content type, held in the terminal's memory.

### Step 2:

Terminal constructs a request message and transmits it to the server.

Terminal converts the structured set of user parameters into a request object, for example a JSON document, that includes fields for character information, nuance category, language, and content identifiers. The input of this step is the in-memory user parameters from Step 1.

Terminal performs data formatting and serialization operations to generate a request message, and then sends the request message to the server over a network interface using a transport protocol. The output of this step is a network message delivered to the server that encodes the character information and nuance category for further processing.

### Step 3:

Server receives and validates the request.

Server accepts the network message via a network interface and passes the payload to an application layer. The input of this step is the serialized request received from the terminal.

Server deserializes the request into an internal data structure, checks that required fields such as character information and nuance category are present, verifies that text length is within configured limits, and confirms that the nuance category is supported. During these checks, server performs string length calculations and table lookups against a stored list of allowed categories. The output of this step is a validated request object, or an error status if validation fails.

### Step 4:

Server executes natural language processing to obtain syntactic and semantic analysis results.

Server passes the character information from the validated request to a natural language processing module. The input of this step is the original character string. Server tokenizes the string into tokens, applies part-of-speech tagging, and constructs a dependency tree by computing syntactic relations using a pre-loaded language model. Server further derives semantic roles and key terms by analyzing the dependency structure and lexical information.

These computations use matrix operations and probabilistic taggers within the language processing library. The output of this step is an analysis result object containing token lists, part-of-speech tags, syntactic dependencies, semantic roles, and extracted key terms.

### Step 5:

Server performs emotion analysis on the character information.

Server forwards the original character information to an emotion analysis engine or executes an internal emotion classification model. The input of this step is the original text from the request. When using an external engine, server sends the text and receives an emotion score vector; when using a local model, server converts tokens into embeddings, passes them through one or more neural layers, and applies a classifier to compute probabilities for emotion categories. These computations involve vector multiplications, non-linear activation functions, and normalization. The output of this step is an emotion representation that includes at least an emotion category, such as “joy” or “anger”, and an emotion intensity value.

### Step 6:

Server selects or adjusts a nuance pattern based on the nuance category and emotion representation.

Server passes the user-selected nuance category and the emotion representation to a nuance pattern management module. The input of this step is the pair of a categorical nuance label and a numeric or categorical emotion representation. Server accesses a plurality of stored nuance patterns, each represented as a parameter record including style, formality, length limits, and vocabulary constraints. Server performs a lookup or a small model inference to choose a base pattern corresponding to the selected nuance category and then adjusts pattern parameters according to the emotion intensity, for example weakening or strengthening emphasis weights. The output of this step is a selected or adjusted nuance pattern object containing concrete parameter values to be enforced in later steps.

### Step 7:

Server constructs a prompt sentence for the generative AI model.

Server invokes a prompt construction module with the analysis result object, the selected nuance pattern, and the original character information. The input of this step is a combination of linguistic analysis data, style constraints, and original text. Server loads a template string for the relevant language and application, substitutes placeholders with the nuance label, any additional constraints such as maximum sentence length, and the original text, and concatenates these segments into a prompt sentence. During this operation, server performs string operations and may apply conditional logic to include or exclude particular instructions. The output of this step is a prompt sentence, such as “Please convert the following sentence into a calm way of speaking: ‘He shouted in anger.’”, stored as a character string ready to be supplied to the generative AI model.

### Step 8:

Server queries the generative AI model with the prompt sentence.

Server passes the prompt sentence and generation parameters to a generative AI model interface. The input of this step is the prompt sentence and a set of numeric parameters controlling generation, such as maximum token count and sampling temperature. Server encodes the prompt sentence into model tokens, sends the token sequence to a transformer-based language model, and receives token outputs generated by the model.

Internally, the generative AI model computes attention scores and hidden state vectors across multiple layers using matrix multiplications and non-linear functions. The output of this step is a generated token sequence representing transformed character information that reflects the requested nuance.

### Step 9:

Server decodes and post-processes the transformed character information.

Server decodes the generated token sequence into a text string. The input of this step is the generated token sequence from the generative AI model. Server converts tokens back to characters, removes any extraneous prefixes or quotations, and measures length in characters.

Server compares the measured length to the length constraint from the nuance pattern and truncates or splits the text if necessary. Server also scans the text for words that violate vocabulary or prohibited-expression constraints using dictionary lookups and regular expression matching, and replaces or removes such words as needed. The output of this step is cleaned, constrained transformed character information that conforms to style and length parameters.

### Step 10:

Server generates display character information and transmits it to the terminal.

Server encapsulates the cleaned transformed character information into a display data structure. The input of this step is the constrained transformed text from Step 9 and metadata from the original request, such as content identifiers and timing information. Server attaches timecodes or usage context, for example for subtitles, sets layout parameters such as maximum characters per line, and formats the data into a response message. Server then serializes this structure and sends it to the terminal through the network interface. The output of this step is a response message containing display character information ready for rendering on the terminal.

### Step 11:

Terminal renders the display character information for the user.

Terminal receives the response message from the server and passes it to a display module.

The input of this step is the serialized display character information, including the transformed text and rendering parameters. Terminal deserializes the data, places the transformed text into a subtitle buffer, chat window, or text area, and draws the text on the display according to positioning and timing metadata. Terminal may overlay the text on video frames or insert it into a conversation view. The output of this step is a visual presentation of the transformed character information on the terminal display, perceivable by the user.

### Step 12:

User reviews the transformed character information and optionally initiates further processing.

User observes the text rendered by the terminal. The input of this step is the visible transformed text produced in Step 11. User evaluates whether the nuance, length, and content are appropriate, and may decide to accept the text, edit it manually on the terminal, or change the nuance category and submit another request to the server. When user initiates another request, the modified text and new nuance category become the input to Step 1 and Step 2 again. The output of this step is either a confirmed use of the transformed character information in a real application context or a new set of user parameters that cause a new iteration of the processing flow.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

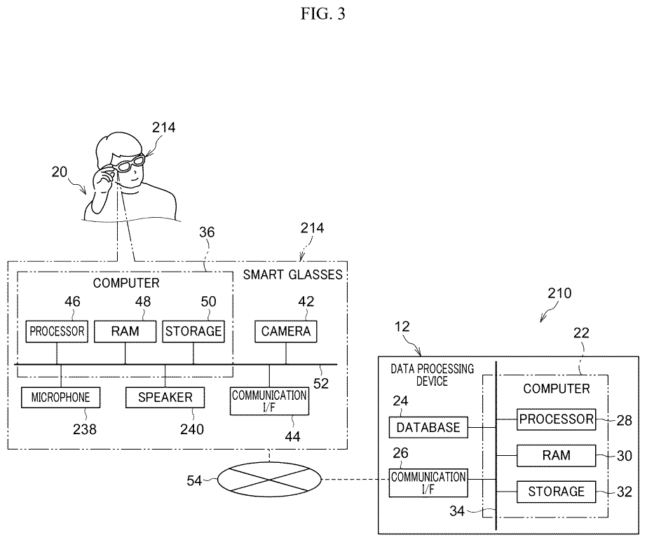

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52.

The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

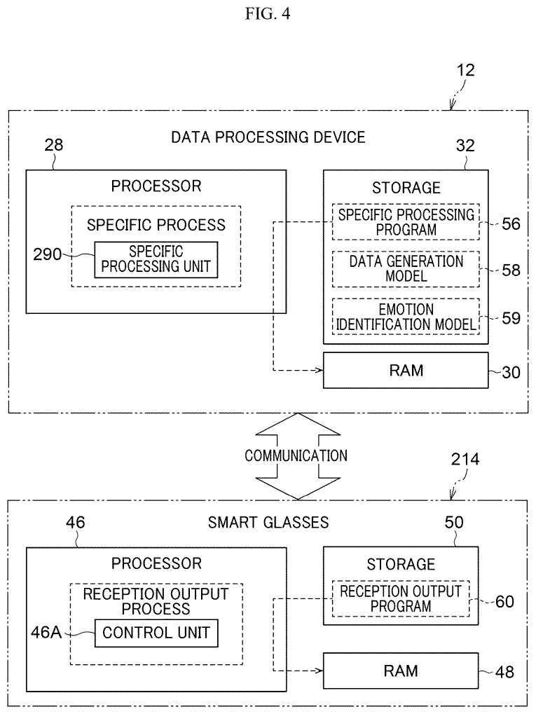

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples.

Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like.

The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

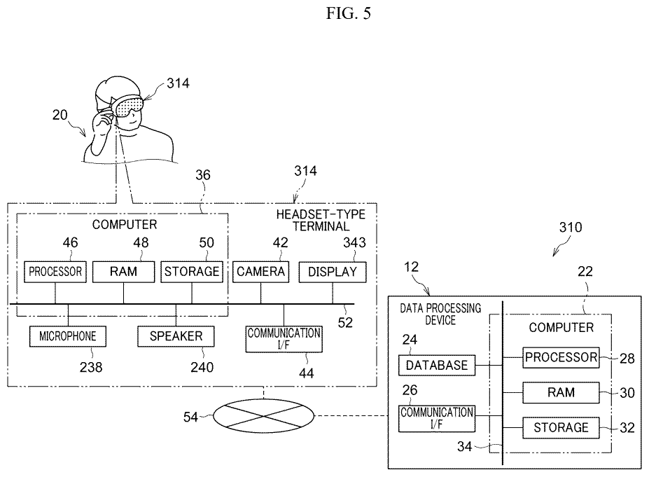

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

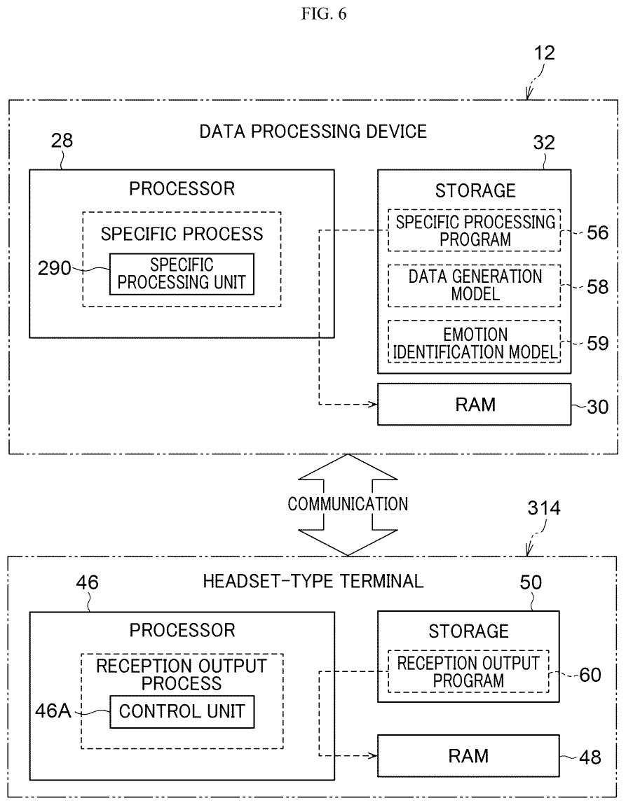

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

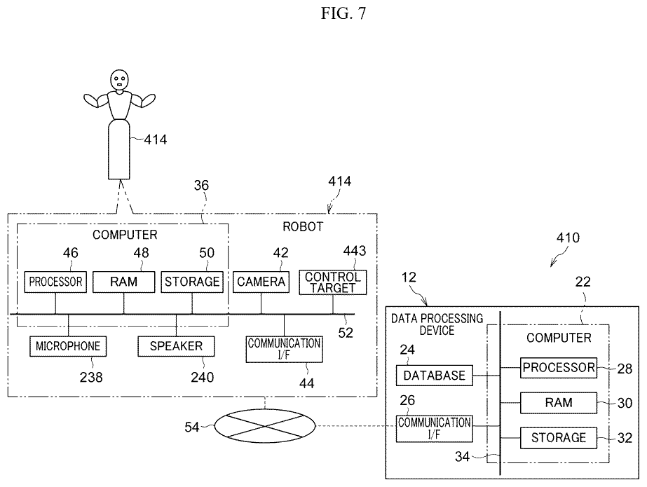

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

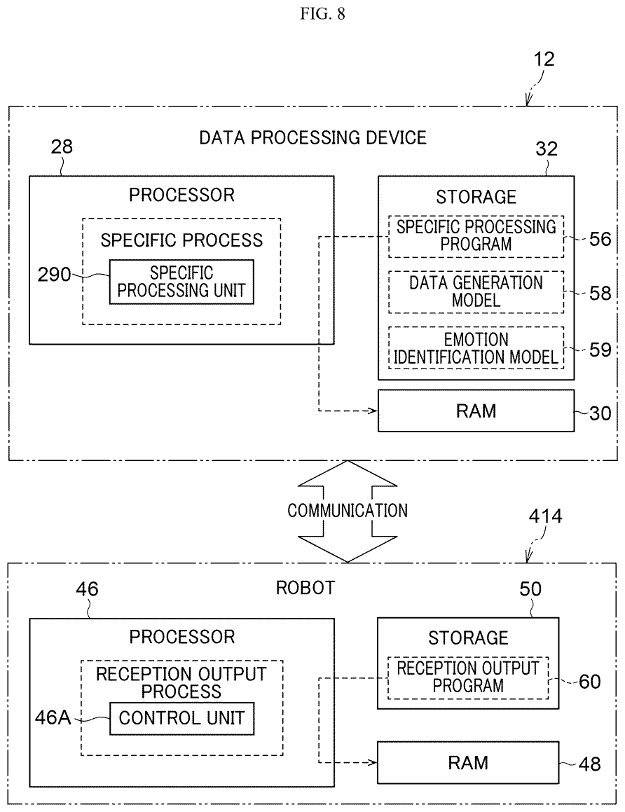

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

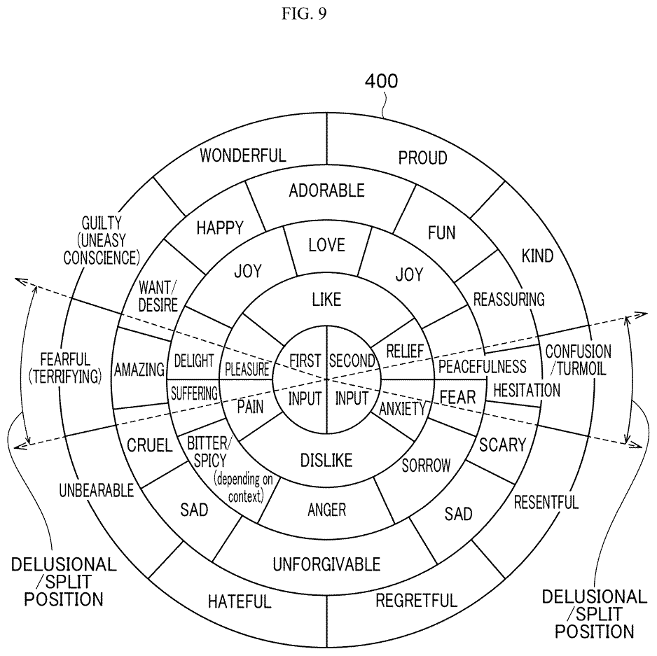

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University).

Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

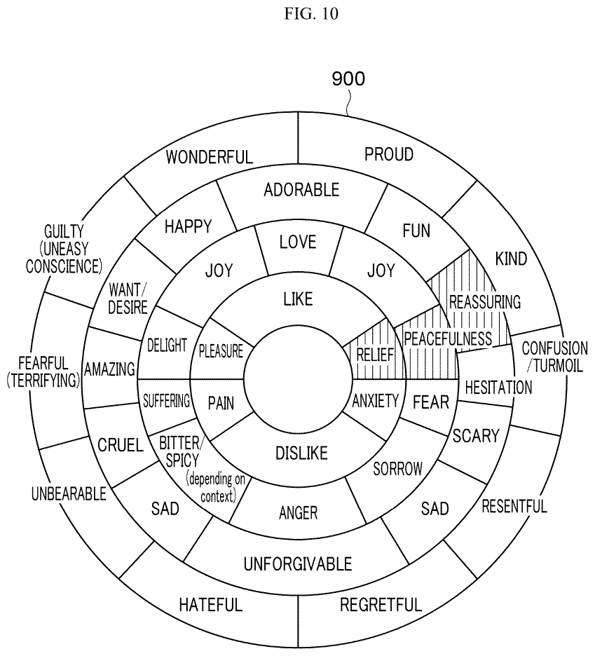

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like.

The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure.

This means that obviously redundant parts may be eliminated, new elements may be added, and switching around may be performed on the described content and drawing content illustrated above within a range not departing from the spirit of the present disclosure.

Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, via a communication path, information input by a user through a terminal and information indicating a meaning selected by the user through the terminal,
construct a prompt sentence for input to a generative AI model by inserting the received user input information and the information indicating the selected meaning into a predetermined template,
transmit the constructed prompt sentence to the generative AI model and cause the generative AI model to execute natural language processing including tokenization of the prompt sentence and matrix operations by a neural network so as to generate converted information that preserves a semantic content of the user input information while reflecting the selected meaning,
acquire the converted information from the generative AI model, format the acquired converted information into output data in a displayable form for the terminal, and transmit the output data to the terminal,
store a plurality of past user input information items transmitted from the terminal and, in association therewith, a plurality of items of information indicating meanings corresponding to the respective user input information items, and perform machine learning processing on the stored information to extract and update a plurality of meaning patterns, and
provide meaning pattern information corresponding to at least part of the extracted and updated plurality of meaning patterns to the terminal so that the meaning patterns are presented as selectable options on the terminal.

### (Supplementary 2)

The system according to supplementary 1,
wherein the processor is configured to perform emotion estimation processing on the information input by the user by using an emotion analysis engine, automatically select,
based on a result of the emotion estimation processing, a meaning pattern to be incorporated into the prompt sentence from among the plurality of meaning patterns, and reflect the selected meaning pattern in construction of the prompt sentence.

### (Supplementary 3)

The system according to supplementary 1,
wherein the processor is configured to input the prompt sentence to the generative AI model by using a generative AI technique, and, after receiving the converted information output from the generative AI model, perform character string normalization processing and removal processing of unnecessary portions on the converted information, and output the processed converted information to the terminal.

### Application Example 1

### (Supplementary 1)

A system comprising a processor,
wherein the processor is configured to
receive sentence data and nuance information input by a user via an information processing terminal,
obtain, from a storage unit, a nuance pattern corresponding to the nuance information, and generate prompt sentence data including the sentence data and the nuance pattern,
transmit the prompt sentence data to an external generative artificial intelligence model and obtain, from the generative artificial intelligence model, converted sentence data to which a nuance is added,
transmit the converted sentence data to the information processing terminal and generate output data for display of the converted sentence data to the user on the information processing terminal,
extract, based on past input and output data, a plurality of nuance patterns, update the plurality of nuance patterns, and generate learning data to be used for generation of the prompt sentence data, and
manage the nuance patterns in association with style constraint information and incorporate the style constraint information into the prompt sentence data.

### (Supplementary 2)

The system according to supplementary 1,
wherein the processor is configured to
execute emotion analysis processing on the sentence data input by the user to estimate emotion information, automatically select at least a part of the nuance patterns based on the emotion information, and reflect the automatically selected nuance patterns in the prompt sentence data.

### (Supplementary 3)

The system according to supplementary 1,
wherein the processor is configured to
accumulate log data including the prompt sentence data and the converted sentence data, analyze and update the nuance patterns and the style constraint information based on the log data, and improve the prompt sentence data to be generated subsequently by using the updated nuance patterns and the updated style constraint information.

### Example 2

### (Supplementary 1)

A system comprising a processor,
wherein the processor is configured to
receive, from a user terminal, an input text and an expression pattern, validate the input text by determining at least a string length and a character type of the input text, normalize the input text, and generate input data for prompt generation,
perform linguistic analysis on the input data, the linguistic analysis including at least morphological analysis, part-of-speech tagging, dependency parsing, and named-entity extraction, and calculate characteristic values indicating expression attributes of the input text, including at least presence or absence of honorific expressions, whether the input text is a request sentence, and a degree of politeness, thereby generating analysis information indicating the expression attributes of the input text,
select, on the basis of the analysis information and the expression pattern acquired from the user terminal, a template of an instruction sentence to be given to a generative AI model, and construct a prompt sentence for the generative AI model by incorporating the input text and constraint conditions corresponding to the expression pattern into the template,
input the prompt sentence, via an interface, to an external generative AI model or an internal generative AI model, cause the generative AI model to execute a generation process for converting the input text into an expression corresponding to the expression pattern, and obtain a converted text as a result of the generation process,
perform post-processing on the converted text, the post-processing including at least language type determination, detection of inappropriate terms, and formatting to a predetermined sentence-ending form, and generate response data including a post-processed converted text that is outputtable to the user terminal, and
store, as history information in a storage device, a correspondence among the input text, the expression pattern, and the converted text, and update at least the template of the prompt sentence and the constraint conditions on the basis of accumulated history information, thereby performing learning of a plurality of expression patterns.

### (Supplementary 2)

The system according to supplementary 1,
wherein the processor is configured to
obtain, from the user terminal, evaluation information regarding a conversion result, associate the evaluation information with a corresponding input text, expression pattern, and converted text, store the associated information, and adjust, on the basis of the evaluation information, at least the template of the prompt sentence, the constraint conditions, and a generation parameter for the generative AI model, thereby improving accuracy and consistency of expression conversion. (Supplementary 3)

The system according to supplementary 1,
wherein the processor is configured to
dynamically generate a plurality of prompt sentences corresponding to a plurality of expression styles including at least polite style, intimate style, and business style, in accordance with the input text and the expression pattern obtained from the user terminal,
obtain, from the generative AI model, a plurality of converted texts by using the plurality of prompt sentences, and select, from among the plurality of converted texts, a converted text to be displayed on the user terminal, thereby enabling iterative modification and comparison of expressions by a user.

### Application Example 2

### (Supplementary 1)

A system comprising a processor,
wherein the processor is configured to
receive, from a terminal, character information input by a user and a nuance category associated with the character information,
execute natural language processing on the character information to perform syntactic analysis and semantic analysis and obtain an analysis result,
execute emotion analysis on the character information to obtain an emotion category and an emotion intensity,
select or adjust a nuance pattern including at least a representation style, a writing style, and a length constraint, on the basis of the emotion category and the nuance category,
construct a prompt sentence on the basis of the analysis result, the nuance pattern, and the character information, the prompt sentence being configured to instruct a generative AI model to generate or transform character information having a predetermined nuance,
input the prompt sentence to the generative AI model and obtain, from the generative AI model, transformed character information having the predetermined nuance,
perform post-processing on the transformed character information on the basis of at least one of the length constraint, a vocabulary constraint, and a prohibited-expression constraint to generate display character information, and
transmit the display character information to the terminal so that the display character information is output as at least one of a subtitle, an explanatory text, and a response text of content.

### (Supplementary 2)

The system according to supplementary 1,
wherein the processor is configured to
extract and update the nuance pattern by performing machine learning on past input-output data, store a plurality of nuance patterns, and automatically select one of the plurality of nuance patterns in accordance with the emotion category and the nuance category specified by the user.

### (Supplementary 3)

The system according to supplementary 1,
wherein the processor is configured to
acquire character information associated with at least one of video content and audio content,
convert the character information in real time or quasi real time during reproduction of the at least one of the video content and the audio content on the basis of the emotion analysis and the selection of the nuance pattern, and cause the terminal to superimpose and display the transformed character information as a subtitle on the at least one of the video content and the audio content.

What is claimed is:

1. A system comprising:
circuitry configured to:
receive, via a communication interface coupled to a packet-switched network, character information and a nuance category from a terminal device, validate the character information by determining at least a string length and a character type, and normalize the character information;
apply linguistic analysis to the normalized character information including at least morphological analysis, part-of-speech tagging, dependency parsing, and named-entity extraction, and calculate characteristic values representing expression attributes of the character information including at least presence or absence of honorific expressions, whether the character information is a request sentence, and a degree of politeness, to generate analysis information;
execute emotion analysis on the character information to obtain an emotion category and an emotion intensity, and select or adjust a nuance pattern including at least a representation style, a writing style, and a length constraint based on the emotion category and the nuance category;
construct a prompt sentence based on the analysis information, the nuance pattern, and the character information, the prompt sentence instructing a generative neural network model to generate transformed character information having a predetermined nuance;
input the prompt sentence to the generative neural network model and obtain transformed character information from the generative neural network model;
apply postprocessing to the transformed character information based on at least one of the length constraint, a vocabulary constraint, and a prohibited-expression constraint to generate display character information; and
transmit the display character information to the terminal device via the communication interface, and store past character information and corresponding nuance categories in a storage device and perform machine learning processing on the stored information to extract and update a plurality of nuance patterns.

2. The system according to claim 1, wherein the circuitry is configured to perform emotion estimation processing on the character information using an emotion analysis engine, automatically select a nuance pattern to be incorporated into the prompt sentence from among the plurality of nuance patterns based on a result of the emotion estimation processing, and reflect the selected nuance pattern in construction of the prompt sentence.

3. The system according to claim 2, wherein the circuitry is configured to provide nuance pattern information corresponding to at least a portion of the extracted and updated plurality of nuance patterns to the terminal device as selectable options, and receive a nuance pattern selection from the terminal device for use in constructing the prompt sentence.

4. The system according to claim 3, wherein the circuitry is configured to manage the nuance patterns in association with style constraint information and incorporate the style constraint information as constraint conditions in the prompt sentence.

5. The system according to claim 4, wherein the circuitry is configured to extract a plurality of nuance patterns from past input and output data stored in the storage device, update the plurality of nuance patterns, and generate learning data to be used for generation of the prompt sentence based on the updated nuance patterns.

6. The system according to claim 1, wherein the circuitry is configured to perform morphological analysis on the character information to identify part-of-speech tags for each token, and apply dependency parsing to extract syntactic relationships including subject-predicate pairs and modifier-head relationships as part of the analysis information.

7. The system according to claim 6, wherein the circuitry is configured to apply named-entity extraction to the character information to identify and classify named entities including at least person names, organization names, and location names, and preserve identified named entities in the transformed character information.

8. The system according to claim 7, wherein the circuitry is configured to calculate a politeness degree score for the character information as a numerical value based on the presence of honorific expressions and the classification of the character information as a request sentence, and use the politeness degree score in selecting a template for the prompt sentence.

9. The system according to claim 8, wherein the circuitry is configured to select a template of an instruction sentence from a plurality of predefined templates based on the analysis information and the expression pattern received from the terminal device, and construct the prompt sentence by incorporating the character information and constraint conditions corresponding to the nuance category into the selected template.

10. The system according to claim 1, wherein the circuitry is configured to apply character string normalization processing and removal processing of unnecessary portions to the transformed character information received from the generative neural network model before generating the display character information.

11. The system according to claim 10, wherein the circuitry is configured to apply a length constraint in the postprocessing to truncate or expand the transformed character information to a target length range specified by the nuance pattern, and apply a prohibited-expression constraint to replace or remove terms in the transformed character information that match a prohibited expression list.

12. The system according to claim 11, wherein the circuitry is configured to store the prompt sentence, the transformed character information, and the display character information in the storage device indexed by session identifier and timestamp as log information, and use the log information as training data in the machine learning processing.

13. The system according to claim 1, wherein the circuitry is configured to receive the character information and a nuance information item indicating a meaning selected by the user via the terminal device, construct the prompt sentence by inserting the character information and the nuance information item into a predetermined template, and cause the generative neural network model to execute natural language processing including tokenization and neural-network-based matrix operations to generate converted information that preserves semantic content of the character information while reflecting the selected meaning.

14. The system according to claim 13, wherein the circuitry is configured to format the converted information into output data in a displayable form and transmit the output data to the terminal device, and provide meaning pattern information corresponding to the extracted and updated plurality of nuance patterns to the terminal device as selectable options.

15. The system according to claim 1, wherein the circuitry is configured to transmit the display character information to the terminal device for output as at least one of a subtitle, an explanatory text, and a response text of content displayed on the terminal device.

16. The system according to claim 15, wherein the circuitry is configured to receive additional character information from the terminal device following transmission of the display character information, apply the linguistic analysis and the emotion analysis to the additional character information, and update the selected nuance pattern based on a detected change in the emotion category.

17. The system according to claim 1, wherein the circuitry is configured to store a plurality of past user input information items and corresponding meaning-indicating information items in the storage device, perform machine learning processing on the stored information to extract and update a plurality of meaning patterns, and accumulate the updated meaning patterns for use in subsequent prompt sentence construction.

18. A system comprising:
circuitry configured to:
receive, via a communication interface coupled to a packet-switched network, character information and a nuance category from a terminal device, validate and normalize the character information;
apply linguistic analysis including morphological analysis, part-of-speech tagging, dependency parsing, and named-entity extraction to generate analysis information, and calculate characteristic values representing at least honorific expression presence, request sentence classification, and politeness degree;
execute emotion analysis on the character information to obtain an emotion category and an emotion intensity, and select a nuance pattern including a representation style, a writing style, and a length constraint based on the emotion category and the nuance category;
construct a prompt sentence based on the analysis information, the nuance pattern, and the character information, input the prompt sentence to a generative neural network model, and obtain transformed character information from the generative neural network model;
apply postprocessing to the transformed character information based on at least the length constraint and a prohibited-expression constraint to generate display character information;
transmit the display character information to the terminal device via the communication interface; and
store past character information and corresponding nuance categories in a storage device, perform machine learning processing on the stored information to extract and update a plurality of nuance patterns, and provide updated nuance pattern information to the terminal device as selectable options.

19. The system according to claim 18, wherein the circuitry is configured to automatically select a nuance pattern from among the plurality of nuance patterns based on the emotion category obtained from the emotion analysis, and reflect the automatically selected nuance pattern in the construction of the prompt sentence without requiring a manual nuance selection from the user.

20. A method comprising:
receiving, by circuitry via a communication interface coupled to a packet-switched network, character information and a nuance category from a terminal device, validating the character information by determining at least a string length and a character type, and normalizing the character information;
applying linguistic analysis to the normalized character information including at least morphological analysis, part-of-speech tagging, dependency parsing, and named-entity extraction, and calculating characteristic values representing expression attributes of the character information including at least presence or absence of honorific expressions, whether the character information is a request sentence, and a degree of politeness, to generate analysis information;
executing emotion analysis on the character information to obtain an emotion category and an emotion intensity, and selecting or adjusting a nuance pattern based on the emotion category and the nuance category;
constructing a prompt sentence based on the analysis information, the nuance pattern, and the character information, and inputting the prompt sentence to a generative neural network model to obtain transformed character information;
applying postprocessing to the transformed character information based on at least one of the length constraint, a vocabulary constraint, and a prohibited-expression constraint to generate display character information; and
transmitting the display character information to the terminal device via the communication interface, and storing past character information and corresponding nuance categories in a storage device and performing machine learning processing on the stored information to extract and update a plurality of nuance patterns.
